(19) United States
(12) Patent Application Publication
(10) Pub. No.: US 2025/0323702 A1
(43) Pub. Date: Oct. 16, 2025

(54) METHOD AND APPARATUS FOR INTELLIGENT BEAM MANAGEMENT IN MOBILE COMMUNICATION SYSTEM

(71) Applicant: Electronics and Telecommunications Research Institute, Daejeon (KR)

(72) Inventors: Yong Jin KWON, Daejeon (KR); Seung Jae Bahng, Daejeon (KR); Young Joon Yoon, Daejeon (KR); An Seok Lee, Daejeon (KR); Heesoo Lee, Daejeon (KR); Yun Joo Kim, Daejeon (KR); Hyun Seo Park, Daejeon (KR); Jung Bo Son, Daejeon (KR); Yu Ro Lee, Daejeon (KR)

(73) Assignee: Electronics and Telecommunications Research Institute, Daejeon (KR)

(21) Appl. No.: 19/057,089

(22) Filed: Feb. 19, 2025

(30) Foreign Application Priority Data
Feb. 19, 2024 (KR) 10-2024-0023777
Mar. 15, 2024 (KR) 10-2024-0036664
May 10, 2024 (KR) 10-2024-0061956

(51) Int. Cl. H04B 7/06; H04B 17/318; H04L 41/16

(52) U.S. Cl. CPC H04B 7/0626; H04B 7/06952; H04B 17/328; H04L 41/16

(57) ABSTRACT

A method of a terminal according to the present disclosure may comprise: receiving, from a base station, CSI-related information including CSI resource configuration information; measuring CSI-RSs respectively received through beams of the base station based on the CSI resource configuration information; generating prediction information for the beams of the base station by using the measured CSI-RSs as inputs to an AI model; and transmitting a report message to the base station based on the prediction information for the beams of the base station.

### CROSS-REFERENCE TO RELATED APPLICATIONS

This application claims priority to Korean Patent Applications No. 10-2024-0023777, filed on Feb. 19, 2024, No. 10-2024-0036664, filed on Mar. 15, 2024, and No. 10-2024-0061956, filed on May 10, 2024, with the Korean Intellectual Property Office (KIPO), the entire contents of which are hereby incorporated by reference.

### BACKGROUND

### 1. Technical Field

The present disclosure relates to a beam management technique in a mobile communication system, and more particularly, to an intelligent beam management technique in a mobile communication system.

### 2. Related Art

Regarding intelligent technologies for mobile communication systems, the international standardization organization 3GPP is currently discussing solutions of applying intelligent technologies for air interfaces as a work item (WI) in release 19. The objective of the work item is to establish use cases in which intelligent technologies can be applied to air interfaces and to carry out necessary specifications for each use case based on the usage of intelligent technologies. Specifically, representative use cases have been selected, including beam management, positioning accuracy enhancement, and channel state information (CSI) feedback enhancement.

However, in a mobile communication system consisting of a base station and one or more terminals, when a terminal is configured to use an intelligent beam management function, methods for managing operations of the intelligent model have not been discussed. Therefore, a solution for managing the operations of the intelligent model is required.

### SUMMARY

The present disclosure for resolving the above-described problems is directed to providing a method and an apparatus for managing operations of an intelligent model, when a terminal is configured to use an intelligent beam management function.

A method of a terminal, according to an exemplary embodiment of the present disclosure, may comprise: receiving, from a base station, channel state information (CSI)-related information including CSI resource configuration information; measuring CSI-reference signals (CSI-RSs) respectively received through beams of the base station based on the CSI resource configuration information; generating prediction information for the beams of the base station by using the measured CSI-RSs as inputs to an artificial intelligence (AI) model; and transmitting a report message to the base station based on the prediction information for the beams of the base station.

In a data collection stage of the AI model, the report message may be set to ‘No report’.

The report message may further include a parameter indicating an inference procedure of the AI model or a performance monitoring procedure of the AI model.

The report message may include only one or more beam indexes based on inference result of the AI model.

The report message may include first information corresponding to a first time instance, which is inferred from the AI model based on measurement of the CSI-RSs, and second information corresponding to a second time instance, which is predicted by the AI model based on measurement of the CSI-RSs, the first information may include pair(s) each comprising each of one or more first beam indexes obtained based on inference of the AI model and a measured received signal received power (RSRP) value corresponding to each of the one or more first beam indexes, and the second information may include pair(s) each comprising each of one or more second beam indexes obtained based on inference of the AI model and a predicted RSRP value corresponding to each of the one or more second beam indexes.

Each of the RSRP value(s) in the second information may be a difference from an RSRP value of a corresponding beam in the first information.

When a difference between the predicted RSRP value corresponding to each of the second beam index(es) included in the second information and an RSRP value corresponding to a beam index corresponding to each of the second beam index(es) included in the first information is within a preset threshold value, the predicted RSRP value may be omitted from the second information.

The report message may include first information corresponding to a first time instance, which is inferred from the AI model based on measurement of the CSI-RSs, and second information corresponding to a second time instance, which is predicted by the AI model based on measurement of the CSI-RSs, the first information may include pair(s) each comprising each of odd-numbered beam index(es) obtained based on inference of the AI model and a measured RSRP value corresponding to each of the odd-numbered beam index(es), and the second information may include pair(s) each comprising each of even-numbered beam index(es) obtained based on inference of the AI model and a predicted RSRP value corresponding to each of the even-numbered beam index(es).

The CSI-related information may further include an identifier related to a pattern of the beams of the base station.

A terminal, according to an exemplary embodiment of the present disclosure, may comprise at least one processor, wherein the at least one processor may cause the terminal to perform: receiving, from a base station, channel state information (CSI)-related information including CSI resource configuration information; measuring CSI-reference signals (CSI-RSs) respectively received through beams of the base station based on the CSI resource configuration information; generating prediction information for the beams of the base station by using the measured CSI-RSs as inputs to an artificial intelligence (AI) model; and transmitting a report message to the base station based on the prediction information for the beams of the base station.

In a data collection stage of the AI model, the report message may be set to ‘No report’.

The report message may further include a parameter indicating an inference procedure of the AI model or a performance monitoring procedure of the AI model.

The report message may include only one or more beam indexes based on inference result of the AI model.

The report message may include first information corresponding to a first time instance, which is inferred from the AI model based on measurement of the CSI-RSs, and second information corresponding to a second time instance, which is predicted by the AI model based on measurement of the CSI-RSs, the first information may include pair(s) each comprising each of one or more first beam indexes obtained based on inference of the AI model and a measured received signal received power (RSRP) value corresponding to each of the one or more first beam indexes, and the second information may include pair(s) each comprising each of one or more second beam indexes obtained based on inference of the AI model and a predicted RSRP value corresponding to each of the one or more second beam indexes.

Each of the RSRP value(s) in the second information may be a difference from an RSRP value of a corresponding beam in the first information.

When a difference between the predicted RSRP value corresponding to each of the second beam index(es) included in the second information and an RSRP value corresponding to a beam index corresponding to each of the second beam index(es) included in the first information is within a preset threshold value, the predicted RSRP value may be omitted from the second information.

The report message may include first information corresponding to a first time instance, which is inferred from the AI model based on measurement of the CSI-RSs, and second information corresponding to a second time instance, which is predicted by the AI model based on measurement of the CSI-RSs, the first information may include pair(s) each comprising each of odd-numbered beam index(es) obtained based on inference of the AI model and a measured RSRP value corresponding to each of the odd-numbered beam index(es), and the second information may include pair(s) each comprising each of even-numbered beam index(es) obtained based on inference of the AI model and a predicted RSRP value corresponding to each of the even-numbered beam index(es).

The CSI-related information may further include an identifier related to a pattern of the beams of the base station.

A method of a base station, according to an exemplary embodiment of the present disclosure, may comprise: transmitting, to a terminal, channel state information (CSI)-related information including CSI resource configuration information; transmitting, to the terminal, CSI-reference signals (CSI-RSs) respectively through beams of the base station based on the CSI resource configuration information; and receiving a report message from the terminal, wherein the report message includes prediction information for the beams of the base station obtained by an artificial intelligence (AI) model included in the terminal.

When the report message is set to ‘No report’, a data collection stage of the AI model may be identified for the terminal.

According to an exemplary embodiment of the present disclosure, the present disclosure provides methods for beam management in a communication system using an intelligent model, such as AI/ML model. In particular, according to the methods and apparatuses of the present disclosure, a base station can reduce the number of beam transmissions for training and/or inference of the AI/ML model. In addition, the base station according to the present disclosure can effectively provide a terminal with configuration information of beams for training and/or inference. Furthermore, when the terminal moves or the base station changes, the terminal can receive information corresponding to a different beam pattern for each base station from a server, thereby maintaining and using the trained AI/ML model as is or rapidly receiving and using a new AI/ML model.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3A is a conceptual diagram for describing selection of a beam pair in a beam management procedure between a base station and a terminal.

FIG. 3B is a conceptual diagram illustrating a case where the beam of the base station is further refined in the beam pair selected based on FIG. 3A.

FIG. 3C is a conceptual diagram illustrating a case where the beam of the terminal is further refined in the beam pair selected based on FIG. 3A.

FIG. 4A is a conceptual diagram illustrating a direct AI/ML positioning method.

FIG. 4B is a conceptual diagram illustrating an AI/ML-assisted positioning method.

FIG. 5 is a conceptual diagram illustrating a structure of an autoencoder.

FIG. 6 is a conceptual diagram illustrating an intelligent beam management technology according to the present disclosure.

FIG. 7A is a conceptual diagram illustrating configuration of a terminal and operations between the terminal and a network when an intelligent model is located in the terminal.

FIG. 7B is a conceptual diagram illustrating configuration of a network and a terminal, as well as operations between the terminal and the network, when an intelligent model is located in the network.

FIG. 8A is a conceptual diagram illustrating a case in which a base station selects directions and sequentially transmits SSBs according to the selected directions and an SSB periodicity.

FIG. 8B is a conceptual diagram illustrating a case in which a base station periodically transmits SSBs according to the first method of the first exemplary embodiment of the present disclosure.

FIG. 8C is a conceptual diagram illustrating a case where a base station periodically transmits SSB according to the second method of the first exemplary embodiment of the present disclosure.

FIG. 8D is a conceptual diagram illustrating a case where a base station periodically transmits SSBs according to the third method of the first exemplary embodiment of the present disclosure.

FIG. 9 is a conceptual diagram illustrating a case where a base station broadcasts cell-specific CSI-RSs to terminals according to the second exemplary embodiment of the present disclosure.

FIG. 10A is a conceptual diagram illustrating a case where a predicted beam is not included in a set of measured beams among beams that a base station can transmit.

FIG. 10B is a conceptual diagram for describing a procedure for inferring information on a predicted beam when the predicted beam is not included in a set of measured beams among beams that a base station can transmit.

FIG. 11A is a conceptual diagram for describing a procedure in which one TCI is finally indicated to a terminal among TCIs configured by a base station.

FIG. 11B is a conceptual diagram for describing a case in which TCI states for AI BM are configured to a terminal through a tci-StateAIBM parameter of an RRC signaling message according to the first method of the third exemplary embodiment of the present disclosure.

FIG. 11C is a conceptual diagram for describing a case in which TCI states for AI BM are configured to a terminal through a two-step configuration using RRC signaling and MAC CE according to the second method of the third exemplary embodiment of the present disclosure.

FIG. 11D is a conceptual diagram for describing a case in which TCI states for AI BM are configured to a terminal through a two-step configuration using RRC signaling and MAC CE according to the third method of the third exemplary embodiment of the present disclosure.

FIG. 12 is a sequence chart illustrating transmission of CSI-RS configuration information, CSI-RS measurement, and CSI reporting.

FIG. 13A is a conceptual diagram for describing a first method in which beam prediction information for multiple time domains is included in a single CSI report message when an intelligent model is located in a terminal.

FIG. 13B is a conceptual diagram for describing a second method in which beam prediction information for multiple time domains is included in a single CSI report when an intelligent model is located in a terminal.

FIG. 13C is a conceptual diagram for describing a first method in which beam measurement information for multiple time domains is included in a single CSI report when an intelligent model is located in a base station.

FIG. 13D is a conceptual diagram for describing a second method in which beam measurement information for multiple time domains is included in a single CSI report when an intelligent model is located in a base station.

FIG. 14A is a conceptual diagram for describing a case where performance consistency is maintained during training and inference procedures of an intelligent model using a beam utilization example.

FIG. 14B is a conceptual diagram for describing a case where performance consistency is not maintained between training and inference procedures of an intelligent model using a beam utilization example.

FIG. 15A is a conceptual diagram for describing a case where performance consistency is not maintained between a training procedure and an inference procedure when a terminal with an intelligent model moves across multiple cells.

FIG. 15B is a conceptual diagram for describing a case in which an intelligent model is provided to a terminal in real time as the terminal moves across multiple cells according to the seventh exemplary embodiment of the present disclosure.

FIG. 16 is a conceptual diagram illustrating a case in which horizontal beams are indexed in a clockwise or counterclockwise direction at equal intervals.

FIG. 17 is a conceptual diagram illustrating a case in which beam indexing is performed for both vertically equidistant beams and horizontally equidistant beams.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g. 6G mobile communication network), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

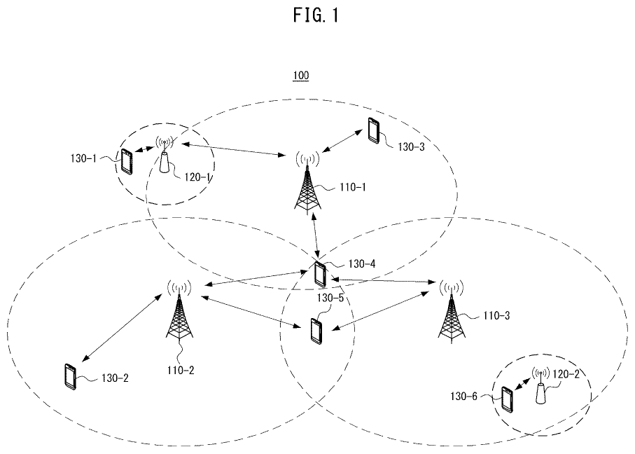

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHz, and the 5G and 6G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

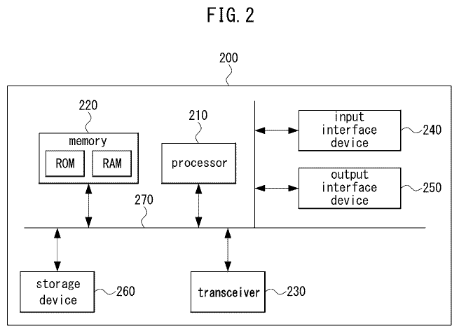

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (COMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission and reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

Meanwhile, intelligent technology may refer to artificial intelligence (AI) and/or machine learning (ML). In the present disclosure described below, the term ‘intelligent technology’ may refer to at least one of AI and ML.

Since intelligent technology is based on training data, a mobile communication system and a terminal supporting the mobile communication system may need to be capable of performing life cycle management (LCM) for generation and maintenance of an intelligent functionality/model in response to changes in the training data. Therefore, as in the use cases described above, when applying a functionality based on intelligent technology in the mobile communication system consisting of a base station and/or the terminal, the mobile communication system and the terminal need to be capable of supporting LCM. In this regard, the 3GPP is discussing detailed steps of the LCM process, including data collection, model training, model inference, model deployment, model activation, model deactivation, model selection, model switching, model fallback, and model monitoring.

For example, when desiring to use intelligent technology, the mobile communication system and/or the terminal may collect data required for a specific intelligent model and perform training for the intelligent model. Additionally, the mobile communication system and/or the terminal may deploy the intelligent model generated through training, and activate the deployed intelligent model. The mobile communication system and/or the terminal may perform inference using the activated intelligent model. Furthermore, the mobile communication system and/or the terminal may manage the intelligent model through intelligent model monitoring.

In the present disclosure, for convenience of description, the types of AI/ML models may be classified into two categories based on a location of a node where AI/ML model inference is performed.
(1) One-sided AI/ML model: an AI/ML model in which inference is entirely performed either in the terminal or in the network
1-1) A case where inference of the AI/ML model is entirely performed in the terminal. The model is referred to as a user equipment (UE)-sided AI/ML model.
1-2) A case where inference of the AI/ML model is entirely performed in the network. The model is referred to as a network (NW)-sided AI/ML model.
(2) Two-sided AI/ML model: an AI/ML model pair in which inference is jointly performed by an AI/ML model of the terminal and an AI/ML model of a network node, wherein joint inference of the AI/ML models includes AI/ML inference jointly performed across the terminal and the network.
2-1) A case where a first part of the AI/ML model inference is performed by the terminal (UE-part of the two-sided model), and the remaining part of the AI/ML model inference is performed by the base station (NW-part of the two-sided model).
2-2) A case where a first part of the AI/ML model inference is performed by the base station (NW-part of the two-sided model), and the remaining part of the AI/ML model inference is performed by the terminal (UE-part of the two-sided model).

Before using the intelligent functionalities and models in the mobile communication system and performing LCM, identification of intelligent functionalities and identification of models need supported in the network to be performed first. For example, the base station may identify which intelligent functionalities and models the terminal can support and may indicate activation of a specific intelligent functionality or model in the terminal based on the identified intelligent functionalities and models. In relation to the identification of intelligent functionalities and models as described above, the 3GPP is discussing the following two LCM directions.
(1) Functionality-based life cycle management (functionality-based LCM)
(2) Model identifier-based life cycle management (model-ID-based LCM)

The functionality-based life cycle management refers to a life cycle management process in which a base station (or a server within the base station) and a terminal (or a server within the terminal) share functionality information for intelligent functionalities in advance, and subsequently, the base station and the terminal identify and manage intelligent functionalities using functionality names or functionality identifiers (IDs).

The model identifier-based life cycle management refers to a life cycle management process in which a base station (or a server within the base station) and a terminal (or a server within the terminal) share information on intelligent models in advance along with model identifiers, and subsequently, the base station and the terminal identify and manage intelligent models using the model identifiers.

The two LCM functions described above may not be configured independently but may be implemented in a mixed form and operate accordingly.

### [Intelligent Beam Management Method]

A cellular mobile communication system has begun using higher frequency bands, including a millimeter-wave (mmWave) band (e.g. 30 GHz to 300 GHz), to accommodate the increase in the number of users and/or the amount of data to be transmitted. When higher frequency bands are used, a wavelength becomes shorter, and a path loss becomes severe, thereby reducing a signal coverage range. As a solution to this issue, the cellular mobile communication system employs a multi-antenna technique that enhances the coverage range by generating directional beams that direct signals toward specific areas.

Generally, power amplification for a base station's beam (i.e. base station beam) transmitting signals from the base station is inversely proportional to a width or area covered by the base station's beam. Therefore, in order to overcome degradation of received signal quality in high-frequency bands, the base station may form multiple transmission beams to cover the entire cell area of the base station. Each of the base station beams may cover an area smaller than the entire coverage area, and in order to compensate for signal propagation loss caused by the use of high-frequency bands, the base station may provide sufficient transmission power to the base station beams.

Since the base station transmits signals using narrow directional beams, a selection process for a base station beam (i.e. Tx beam) and a terminal beam (i.e. Rx beam) that achieve optimal performance between the base station and the terminal is necessary to ensure reliable link performance. As a method for selecting an optimal beam, the base station may need to receive measurement results for all available beams from the terminal. As another method for selecting an optimal beam, a limited number of multiple beams may be measured depending on an implementation scheme of the base station or the terminal, and the optimal beam may be selected based on the measured results. In the process of selecting an optimal beam, overhead may occur. Additionally, if the procedure for selecting an optimal beam is performed frequently, it may cause degradation of communication quality and/or increased power consumption in the terminal.

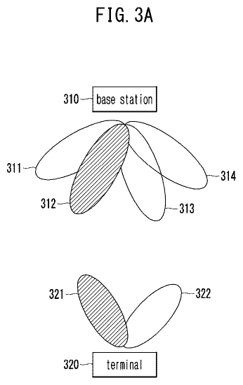

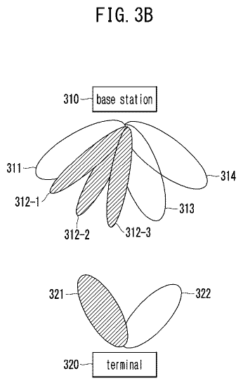

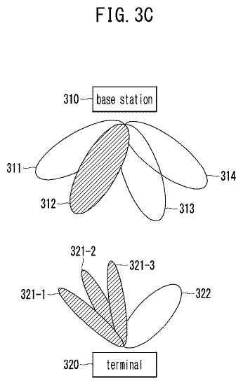

FIG. 3A is a conceptual diagram for describing selection of a beam pair in a beam management procedure between a base station and a terminal.

Referring to FIG. 3A, a base station 310 and a terminal 320 may each configure multiple beams for transmitting signals (including data and/or control information) using the beams. The base station 310 may form multiple beams 311, 312, 313, and 314, and the terminal 320 may also form multiple beams 321 and 322. Assuming that the base station 310 transmits a signal, the base station 310 may transmit the signal through the multiple beams 311, 312, 313, and 314. The terminal 320 may form multiple beams 321 and 322 to receive at least one beam transmitted by the base station 310.

In order to determine a beam pair, the base station 310 may transmit a specific reference signal (RS) to the terminal, and the terminal 320 may receive the RS transmitted through each of the transmission beams 311, 312, 313, and 314 by using the reception beams 321 and 322. Additionally, the terminal 320 may measure a received signal received power (RSRP) of the received RS and report a measurement result to the base station 310. Through this procedure, a transmission beam of the base station 310 and a reception beam of the terminal 320 may be determined as a beam pair for communication. FIG. 3A illustrates a case in which one beam 312 among the transmission beams 311, 312, 313, and 314 of the base station 310 and one beam 321 among the reception beams 321 and 322 of the terminal 320 are selected as a beam pair for communication.

FIG. 3B is a conceptual diagram illustrating a case where the beam of the base station is further refined in the beam pair selected based on FIG. 3A.

Referring to FIG. 3B, when the beam pair is selected as in FIG. 3A, the base station 310 and the terminal 320 may form refined beams 312-1, 312-2, and 312-3 from the transmission beam 312. The base station 310 may transmit the refined beams 312-1, 312-2, and 312-3 corresponding to the transmission beam 312 selected as belonging to the beam pair, and the terminal 320 may receive a signal transmitted by the base station through one beam 321 as in FIG. 3A. When transmitting a signal to the terminal 320, the base station 310 may use all the refined beams 312-1, 312-2, and 312-3 to transmit the signal, or may select only one suitable beam among the refined beams 312-1, 312-2, and 312-3 to transmit the signal. In other words, FIG. 3B illustrates a procedure for further refining the beam of the base station 310 in the beam pair determined in FIG. 3A.

FIG. 3C is a conceptual diagram illustrating a case where the beam of the terminal is further refined in the beam pair selected based on FIG. 3A.

Referring to FIG. 3C, when the beam pair is selected as in FIG. 3A, the base station 310 and the terminal 320 may form refined beams 321-1, 321-2, and 321-3 from the reception beam 321. The base station 310 may transmit a signal to the terminal 320 through the selected transmission beam 312. Additionally, the terminal 320 may receive the signal transmitted from the transmission beam 312 using the refined beams 321-1, 321-2, and 321-3 corresponding to the selected reception beam 321. The terminal 320 may receive the signal using all of the refined reception beams 321-1, 321-2, and 321-3, or may select only one suitable beam among the refined reception beams 321-1, 321-2, and 321-3. In other words, FIG. 3C illustrates a procedure for further refining the beam of the terminal 320 in the beam pair determined in FIG. 3A.

As described above, in order to address the issues in the process of finding and selecting the optimal beams, intelligent technology may be introduced into the beam management process. The beam management technology using intelligent technology may reduce the overhead in the conventional beam measurement while maintaining accuracy. In the intelligent technology-based beam management, beam prediction is being discussed as a use case in which intelligent technology is applied to predict beams of resources that have not been measured in the spatial or time domain.

### [Intelligent Positioning Enhancement Method]

In a mobile communication system, positioning refers to a technique for measuring a location of a specific terminal. According to the 5G NR technical specifications defined by the 3GPP, positioning reference signals (PRS) are transmitted to enable the terminal to report reference signal time differences (RSTDs). Additionally, according to the 5G NR technical specifications defined by the 3GPP, the base station is defined to apply an observed time difference of arrival (OTDOA) positioning measurement technique.

Recently, there has been an increasing demand for higher positioning accuracy, particularly in indoor environments, and techniques applying intelligent technology to improve the accuracy of positioning measurements are being discussed. In intelligent technology-based positioning, two use cases are being discussed: AI/ML-assisted positioning, in which intelligent technology is applied to enhance the accuracy of conventional positioning techniques, and direct AI/ML positioning, in which intelligent technology is applied to directly estimate a location of a terminal.

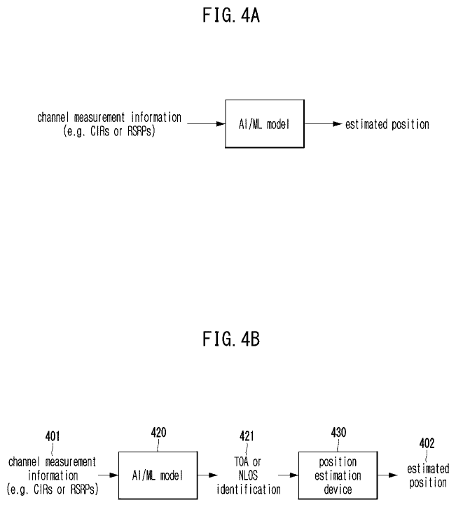

FIG. 4A is a conceptual diagram illustrating a direct AI/ML positioning method.

Referring to FIG. 4A, an AI/ML model 410 is illustrated. The AI/ML model 410 illustrated in FIG. 4A may be an AI/ML model located in a base station. The AI/ML model 410 may take channel measurement information 401 as inputs. In FIG. 4A, as an example of the channel measurement information 401, a channel impulse response (CIR) or received signal received power (RSRP) is illustrated. The CIR or RSRP may be measured by a terminal and reported to the base station. Therefore, to measure the CIR or RSRP, the base station may transmit a specific signal, such as a channel impulse or an RS, to the terminal. It should be noted that in FIG. 4A, a procedure for measuring the CIR or RSRP is omitted. The AI/ML model 410 may infer a position of the terminal based on the channel measurement information 401 and output a location 402 of the terminal, which is estimated through inference.

FIG. 4B is a conceptual diagram illustrating an AI/ML-assisted positioning method.

Referring to FIG. 4B, an AI/ML model 420 is illustrated. The AI/ML model 420 illustrated in FIG. 4B may be an AI/ML model located in a base station. The AI/ML model 420 may be the same AI/ML model as the AI/ML model 410 illustrated in FIG. 4A or may be a different AI/ML model.

The AI/ML model 420 illustrated in FIG. 4B may take the channel measurement information 401 as input. In FIG. 4B, as an example of channel measurement information 401, a CIR or RSRP is illustrated. The CIR or RSRP may be measured by a terminal and reported to the base station. Therefore, to measure the CIR or RSRP, the base station may transmit a specific signal, such as a channel impulse or an RS, to the terminal. It should be noted that in FIG. 4B, a procedure for measuring the CIR or RSRP is omitted.

The AI/ML model 420 may output refined data 421 or enhanced data 421 based on the channel measurement information 401. In the following description, for convenience of description, it is assumed that the output of the AI/ML model 420 illustrated in FIG. 4B is the refined data 421. In FIG. 4B, as an example of the refined data 421, a time of arrival (TOA) or non-line of sight (NLOS) identification information is illustrated.

The refined data 421 may be input into a position estimation device 430. In FIG. 4B, the position estimation device 430 may be a general position estimation device that does not use an AI/ML model. In other words, the position estimation device 430 may be a device that estimates a position of the terminal based on the TOA or NLOS identification information. Therefore, the position estimation device 430 may output an estimated position 431 of the terminal based on the input information.

### [Intelligent Channel Information Feedback Enhancement Method]

Channel state information (CSI) feedback may refer to a process in which a terminal reports CSI to enable a base station to apply transmission techniques such as multiple input multiple output (MIMO) or precoding in a mobile communication system. According to the 5G NR technical specifications defined by the 3GPP, feedback information such as channel quality indicator (CQI), precoding matrix indicator (PMI), and rank indicator (RI) may be supported in relation to the CSI feedback scheme. In the NR system, discussions are ongoing regarding improvements to the CSI feedback scheme to effectively support transmission techniques such as multi-user MIMO (MU-MIMO).

Among intelligent techniques incorporating AI/ML into CSI feedback, use of an autoencoder is being discussed. The use of an autoencoder is being discussed in relation to CSI compression techniques, which aim to obtain compressed latent representations of a MIMO channel.

FIG. 5 is a conceptual diagram illustrating a structure of an autoencoder.

Referring to FIG. 5, an autoencoder may include an encoder 510 and a decoder 520. The encoder 510 may have an input layer, hidden layer(s), and an output layer, and the decoder 520 may also have an input layer, hidden layer(s), and an output layer. In this case, the autoencoder may be represented such that the output layer of the encoder 510 and the input layer of the decoder 520 are treated as a single layer.

In FIG. 5, all layers between the input layer of the encoder 510 and the output layer of the decoder 520 may be hidden layers. As illustrated in FIG. 5, the autoencoder is characterized by having fewer neurons in each of the hidden layers than in the input layer, thereby enabling data compression (or dimensionality reduction.

Based on the above description, in the present disclosure described below, methods and apparatuses are provided for a base station to manage and support operations of an intelligent model when a terminal in a mobile communication system, which includes the base station and one or more terminals, is configured to use an intelligent beam management functionality. Specifically, a procedure for the base station to transmit reference signals for beam performance measurement to the terminal and a method for expressing a relationship between different beams are described. Additionally, a procedure for the base station to configure inputs/outputs for operations of the intelligent model and to support transmission of information related to the inputs/outputs is described.

In the following description, for convenience of description, the methods and apparatuses for managing operations of the intelligent model proposed in the present disclosure will mainly be described from the perspective of downlink in the wireless mobile communication system composed of the base station and the terminal. However, the methods proposed in the present disclosure may be extended and applied to any wireless mobile communication system composed of a transmitter and a receiver. Additionally, in the following description, the present disclosure will be described in terms of use cases being discussed in the 3GPP 5G NR standardization, including the intelligent beam management method, the intelligent channel feedback enhancement method, and the intelligent positioning enhancement method. However, the methods proposed in the present disclosure may also be extended and applied to intelligent use cases in any wireless mobile communication system composed of a transmitter and a receiver.

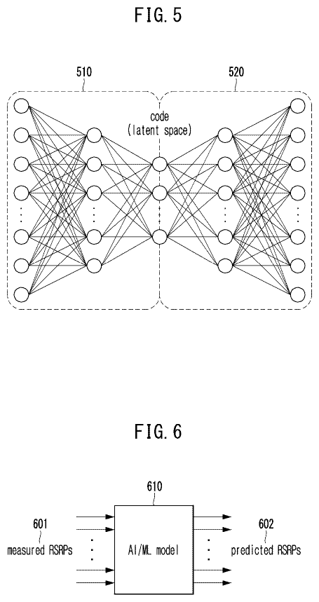

FIG. 6 is a conceptual diagram illustrating an intelligent beam management technology according to the present disclosure.

Referring to FIG. 6, an AI/ML model 610 may take measured RSRPs 601 as inputs, which are an example of channel measurement information, and may output a predicted RSRP 602 through inference. As illustrated in FIG. 6, in order for the AI/ML model 610 using intelligent beam management technology to select an optimal beam through inference, performance values for specific beams are required. In other words, a channel measurement procedure between a transmitting node and a receiving node is necessary. In FIG. 6, the performance may be indicated as a layer 1 (L1)-RSRP or L1-signal to interference plus noise ratio (SINR) measured by the terminal. The measured beam performance may be input into the AI/ML model 610, which is an intelligent model.

The AI/ML model 610 may be used to obtain a result (i.e. output) through inference using input values. The result of the intelligent model may be the predicted RSRP 602, which may be used to acquire an index of a beam with the optimal performance or the performance (e.g. L1-RSRPs) of all available beams. Generally, signals used in the beam performance measurement process may include synchronization signal blocks (SSBs) or channel state information-reference signals (CSI-RSs). In other words, the base station may transmit predetermined RSs to the terminal to perform beam performance measurement.

As illustrated in FIG. 6, an important aspect of the beam performance measurement process for inputs into the AI/ML model 610 is determining a base station beam or beam pair (e.g. both the base station's beam and the terminal's beam) to be used for performance measurement. When an exhaustive search scheme is used to obtain measurement results for all base station beams or all beam pairs, the AI/ML model 610 may determine a base station beam or beam pair that provides optimal performance in any situation.

When the exhaustive search scheme described above is used, overhead may occur during the channel measurement process between the base station and the terminal. In other words, since the exhaustive search scheme results in overhead in the measurement process, it is essential to reduce performance measurements for unnecessary beams.

Meanwhile, the intelligent model for beam selection, that is, the AI/ML model 610 illustrated in FIG. 6, may be independently located in either the base station or the terminal. If the intelligent model is located in the base station, an additional process is required in which the terminal transmits information on measured beam performances to the base station as inputs to the AI/ML model 610. On the other hand, if the AI/ML model 610 is located in the terminal, a process is required in which the results output by the intelligent model are transmitted to the base station.

As described above, the intelligent model performing intelligent beam management technology may be located on the terminal side (i.e. UE-side) or on the network side (i.e. NW-side). Differentiating between these locations is necessary because the operations that the base station and the terminal need to perform to support intelligent beam management technology may differ depending on the location of the intelligent model. The operations required for intelligent beam management may include LCM operations such as data collection for training, inference, and model monitoring (or performance monitoring).

Hereinafter, a case where intelligent beam management is performed in the terminal and a case where intelligent beam management is performed in the network (e.g. the base station) are respectively described.

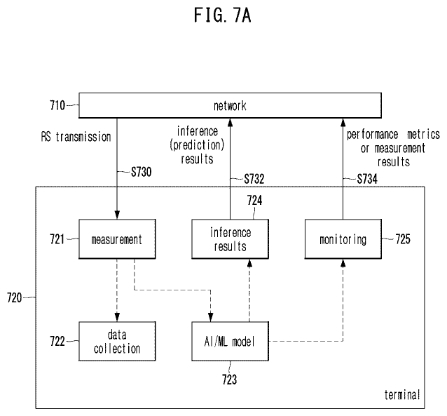

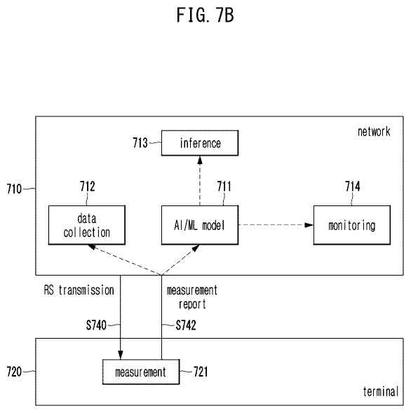

FIG. 7A is a conceptual diagram illustrating configuration of a terminal and operations between the terminal and a network when an intelligent model is located in the terminal.

Referring to FIG. 7A, a network 710 and a terminal 720 are illustrated. In FIG. 7A, the network 710 may be a base station of a cellular system. In step S730, the base station may transmit RSs to the terminal. In this case, as described above, the RS may be an SSB and/or a CSI-RS. Additionally, the RSs may be transmitted through all beams that the base station can transmit or through a predetermined number of specific beams, as described in the various exemplary embodiments below.

In step S730, the terminal 720 may receive the RSs transmitted by the base station through each beam of the base station. In this case, as described in FIGS. 3A to 3C, the terminal 720 may form a reception beam to receive the RS through each beam transmitted by the base station.

The terminal 720 may measure the RSs transmitted by the base station 710 using a measurement device 721. For both the case where intelligent beam management is performed in the terminal and the case where intelligent beam management is performed in the network (e.g. the base station), the procedure for measuring the RSs transmitted by the base station may be performed in the terminal 720. In other words, the RS measurement procedure may be an essential operation of the terminal 720.

The terminal 720 may perform data collection 722 for training an AI/ML model 723 based on the measured RSs. Since the example in FIG. 7A corresponds to the case where the AI/ML model 723, which is an intelligent model, is located in the terminal 720, the results obtained by measuring the beams may be directly used in the data collection and inference processes for training. The data collection 722 may include a procedure for storing the information on the measured RSs in a storage medium such as memory.

Since the terminal 720 is the entity performing the measurement, the beam measurement results may not need to be transmitted to the base station 710 during the data collection procedure and inference process for training. However, even if the measurement results are not transmitted to the base station 710 during the inference process, the results predicted using the AI/ML model 723 need to be transmitted to the base station 710. Therefore, in step S732, the terminal 720 may transmit an inference result 724 to the network (e.g. the base station) 710. Here, the inference result 724 may be a predicted result.

Additionally, when performing a monitoring operation 725 for the AI/ML model 723, the terminal 720 may calculate a performance metric. When the terminal 720 calculates the performance metric, the terminal 720 may calculate the performance metric based on the measurement results. In step S734, the terminal 720 may deliver the calculated performance metric to the network 710. If the performance metric calculation is performed in the network, the terminal may need to transmit the beam measurement information and the output information of the intelligent model to the base station for performance metric calculation.

FIG. 7B is a conceptual diagram illustrating configuration of a network and a terminal, as well as operations between the terminal and the network, when an intelligent model is located in the network.

Referring to FIG. 7B, the network 710 and the terminal 720 are illustrated. In FIG. 7B, the network 710 may be a base station of a cellular system. In step S740, the base station may transmit RSs to the terminal. In this case, as described above, the RS may be an SSB and/or a CSI-RS. Additionally, the RSs may be transmitted through all beams that the base station can transmit or through a predetermined number of specific beams, as described in the various exemplary embodiments below.

In step S740, the terminal 720 may receive the RSs transmitted by the base station through each beam of the base station. In this case, as described in FIGS. 3A to 3C, the terminal 720 may form a reception beam to receive the RS through each beam transmitted by the base station.

The terminal 720 may measure the RSs transmitted by the base station 710 using the measurement device 721. For both the case where intelligent beam management is performed in the terminal and the case where intelligent beam management is performed in the network (e.g. the base station), the procedure for measuring the RSs transmitted by the base station may be performed in the terminal 720. In other words, the RS measurement procedure may be an essential operation of the terminal 720.

In step S724, the terminal 720 may transmit a measurement report for the RSs measured through the measurement device 721 to the network 710. The base station 710 may receive the measurement report for the RSs from the terminal 720. In this case, the measurement report for the RSs may include information on the beams through which the RSs were transmitted.

The base station 710 may use information of the received measurement report as inputs to the AI/ML model 711. By storing the information of the received measurement report, the base station 710 may perform data collection 712. The data collection 712 may include a procedure for storing the information of the measurement report received from the terminal 720 in a storage medium such as memory.

Since the example in FIG. 7B corresponds to the case where the AI/ML model 711, which is an intelligent model, is located in the base station 710, the AI/ML model 711 may perform inference 713. In the example of FIG. 7B, the inference 713 may be an output of the inference. Additionally, the base station 710 may perform monitoring 714 of the AI/ML model 711. The monitoring 714 in FIG. 7B may refer to performance metric calculation, as described in FIG. 7A. If the terminal 720 is able to provide information required for calculation of the performance metric, the terminal 720 may transmit the necessary information, such as measurement information, to the base station 710 for performance metric calculation.

The intelligent beam management technology may be classified into two detailed cases: spatial-domain beam prediction and temporal-domain beam prediction. The spatial-domain beam prediction may refer to selecting an optimal beam for a specific time using beam performance results measured at specific times. The temporal-domain beam prediction may refer to selecting an optimal beam at a current or future time using beam performance results measured at a current and past time.

### First Exemplary Embodiment

In the intelligent beam management process using an AI/ML model, a procedure for obtaining input data for the AI/ML model needs to be performed to carry out beam prediction. The input data of the AI/ML model may include channel information measured by a receiving node. To acquire channel measurement information, a transmitting node (e.g. base station) may transmit preconfigured RSs to the receiving node (e.g. terminal), as described above. The receiving node may acquire channel information by measuring the RSs received from the transmitting node. The acquisition of channel information may be performed differently depending on whether the receiving node has an AI/ML model or whether the transmitting node has an AI/ML model, as described above.

In the 5G NR communication system, synchronization signal blocks (SSBs) and CSI-RSs may be used for beam performance measurement. In the present disclosure, beam performance may be understood as identical or similar to channel state information. Additionally, for convenience or description, the transmitting node is assumed to be a base station, and the receiving node is assumed to be a terminal.

The base station may transmit beamformed downlink RSs to the terminal, and the terminal may receive and measure the downlink RSs. The terminal may perform beam reporting based on the measured results. A beam report may include an identifier (RS ID) of a downlink RS preferred by the terminal and an L1-RSRP corresponding to the downlink RS. The downlink RS ID may be an SSB resource indicator (SSBRI) or a CSI-RS resource indicator (CRI).

An SSB may be composed of four orthogonal frequency division multiplexing (OFDM) symbols in the time domain. The SSB may include a primary synchronization signal (PSS), a secondary synchronization signal (SSS), and a physical broadcast channel (PBCH) associated with a demodulation reference signal (DMRS). The PSS, SSS, and PBCH included in the SSB may be mapped to the four OFDM symbols. In the 5G NR system, multiple SSBs may be transmitted at different times. The multiple SSBs may be used for initial access and serving cell measurement by the terminal. Therefore, the base station may broadcast transmission time(s) and resource allocation information related to the SSB(s) or transmit the information to the terminal(s) through UE-specific RRC signaling.

Generally, in a downlink beam management process, SSB transmission may be used for coarse beam measurement, while CSI-RS transmission may be used for fine beam measurement. During the beam measurement process using SSB transmission, the terminal may perform reception (Rx) beam sweeping by switching reception beams of the terminal during multiple SSB burst periods for a beam with the same SSBRI. Here, a single SSB burst may include one or more SSBs. The SSB burst is always located within a 5 ms window and may be positioned within the first or second half-frame of a 10 ms radio frame. The maximum number L max of SSBs that can be transmitted within an SSB burst may vary depending on an operating frequency band. In a frequency band of 3 GHz or below, up to 4 SSBs may be transmitted. If a frequency band between 3 GHz and 6 GHz, up to 8 SSBs may be transmitted. If a frequency band of 6 GHz or above, up to 64 SSBs may be transmitted.

According to the 5G NR communication system specifications, information on positions of active SSBs within an SSB burst set may be provided through a system information block 1 (SIB1), which is one of system information.

In the SIB1, ServingCellConfigCommonSIB, which is an information element (IE) used to configure cell-specific parameters for a serving cell of the terminal, may be exemplified as shown in Table 1.

TABLE 1

```
ServingCellConfigCommonSIB ::= SEQUENCE {
        downlinkConfigCommon DownlinkConfigCommonSIB,
        uplinkConfigCommon UplinkConfigCommonSIB
        supplementaryUplink UplinkConfigCommonSIB
        n-TimingAdvanceOffset ENUMERATED { n0, n25600, n39936 }
        ssb-PositionsInBurst SEQUENCE {
          inOneGroup BIT STRING (SIZE (8)),
          groupPresence BIT STRING (SIZE (8))
        },
        ssb-PeriodicityServingCell ENUMERATED {ms5, ms10, ms20, ms40, ms80,
ms160},
        tdd-UL-DL-ConfigurationCommon TDD-UL-DL-ConfigCommon
        ss-PBCH-BlockPower INTEGER (−60..50),
        ...,
}
```

The base station may provide the terminal with information on the SSBs by transmitting the ServingCellConfigCommonSIB IE of Table 1. For example, the base station may use ssb-PositionsInBurst information to provide the terminal with information on which SSBs are actually transmitted within the SSB burst. Each bit in an inOneGroup field may indicate to the terminal whether an SSB is transmitted at the corresponding time position. If a bit is set to ‘0’, it may indicate that no SSB is transmitted at the corresponding position. Conversely, if a bit is set to ‘1’, it may indicate that an SSB is transmitted at the corresponding position. In a frequency band of 6 GHz or above (FR2), the base station may use a groupPresence field to indicate to the terminal whether each group is active. Therefore, if the base station transmits 64 SSBs, a maximum of 8 groups may exist.

As another method, the base station may directly transmit an RRC message to the terminal to indicate information on valid SSB(s) within the SSB burst. Specifically, the base station may use the ssb-PositionsInBurst field of the ServingCellConfigCommon IE to indicate information on valid SSB(s) within the SSB burst.

For example, if a specific bit in the ssb-PositionsInBurst field, which is configured as bitmap-type information, is set to ‘0’, it may indicate that no SSB is transmitted at a transmission time corresponding to that bit. Conversely, if a specific bit in the ssb-PositionsInBurst field is set to ‘1’, it may indicate that an SSB is transmitted at a transmission time corresponding to that bit. As described above, since the maximum number L_max of SSBs that can be transmitted within an SSB burst varies depending on the operating frequency band, the ssb-PositionsInBurst field, which is configured as bitmap-type information, may be used as being classified in form of a short bitmap, a medium bitmap, or a long bitmap. As exemplified in Table 1, an SSB transmission periodicity may be configured through an RRC parameter ssb-PeriodicityServingCell. According to the example in Table 1, the SSB transmission periodicity may have one value among 5 ms, 10 ms, 20 ms, 40 ms, 80 ms, or 160 ms.

As described above, since SSB transmission is used during the initial access process of the terminal, it is common for the base station to sequentially transmit SSBs in different directions to cover all beam directions. An example in which the base station selects directions and sequentially transmits SSBs according to the selected directions is described with reference to the accompanying drawings.

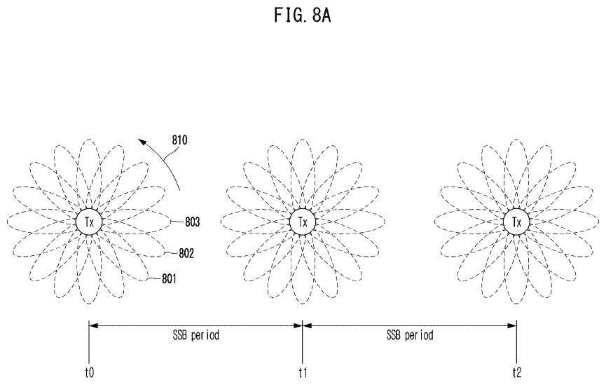

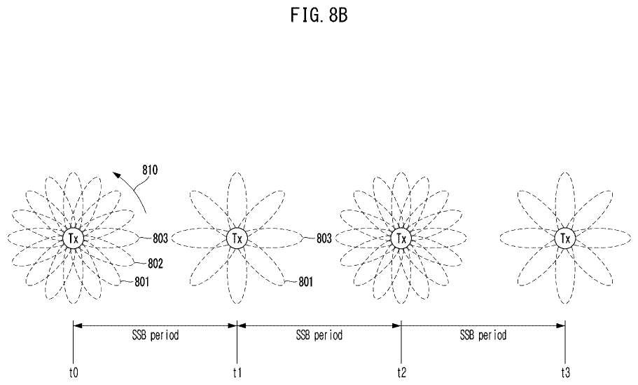

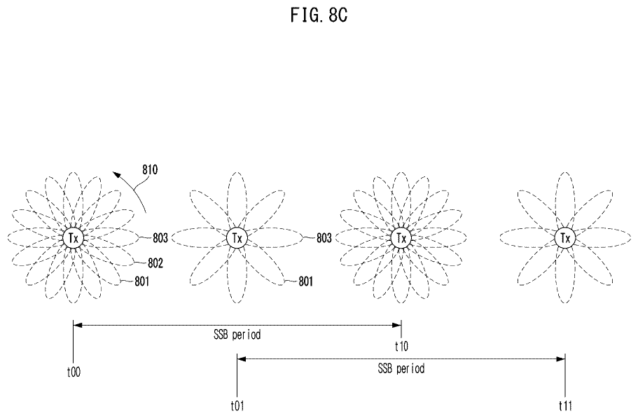

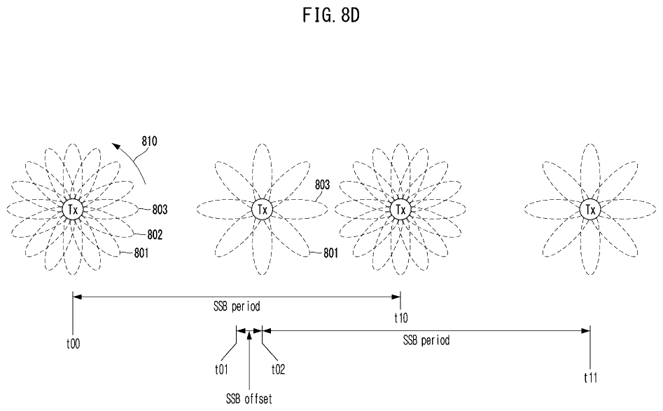

FIG. 8A is a conceptual diagram illustrating a case in which a base station selects directions and sequentially transmits SSBs according to the selected directions and an SSB periodicity.

Referring to FIG. 8A, a base station may be represented as ‘Tx’, and the horizontal arrows below may represent time. At a time t0, the base station (Tx) may sequentially transmit signals using multiple transmission beams to cover all directions of the base station. Here, since the transmission beams refer to beams transmitted by the base station, they may be understood as ‘base station beams’. In other words, the base station (Tx) may transmit the beams in the order of a first transmission beam 801, a second transmission beam 802, and a third transmission beam 803. As illustrated in FIG. 8A, the directions of the first transmission beam 801, the second transmission beam 802, and the third transmission beam 803 may each be different beam directions. In other words, each beam transmitted by the base station (Tx) may have directivity. Additionally, each transmission beam may transmit an SSB. The order in which the beams are sequentially transmitted is illustrated through an arrow of reference numeral 810 in FIG. 8A.

At a time t1 after one SSB transmission period has elapsed, the base station (Tx) may sequentially transmit transmission beams to cover all directions, with each beam transmitting an SSB. The transmission order of the beams at this time may be the same as that at the time t0. Therefore, an interval from the time t0 to the time t1 may correspond to one SSB transmission period. At a time t2 after another SSB transmission period had elapsed, the base station (Tx) may again sequentially transmit transmission beams to cover all directions, with each beam transmitting an SSB. The transmission order of the beams at this time may be the same as that at the time t0.

As described in FIG. 8A, the SSB may be transmitted through each beam. The number of beams transmitting the SSBs may be determined based on a beamwidth for the SSB transmission. Therefore, when the beamwidth is fixed, the total number of beams transmitting the SSBs may remain the same.

When transmitting the SSBs in the same manner as described in FIG. 8A, the intelligent beam management technology according to the present disclosure may reduce the number of beam measurements performed by the terminal, thereby reducing the measurement overhead and power consumption caused by the measurements.

Meanwhile, one of the objectives of the intelligent beam management technology is to reduce the number of times the base station transmits base station beams for beam management, thereby reducing the RS overhead of the base station. Therefore, in the first exemplary embodiment described below, methods for reducing the number of times the base station transmits base station beams for beam management are described.

### First Method of the First Exemplary Embodiment

In general, when using intelligent beam prediction technology, simply increasing the SSB transmission periodicity may reduce the number of base station beam transmissions per unit time. However, increasing the SSB transmission periodicity may cause delays in beam performance measurement (or channel measurement) for terminals that do not use intelligent beam management technology or terminals attempting initial access. Therefore, as illustrated in FIG. 8B, by maintaining the SSB transmission periodicity while changing (reducing) the number of SSBs transmitted at a specific time, the number of base station beam transmissions per unit time may be reduced when using intelligent beam prediction.

FIG. 8B is a conceptual diagram illustrating a case in which a base station periodically transmits SSBs according to the first method of the first exemplary embodiment of the present disclosure.

Referring to FIG. 8B, the base station may be represented as ‘Tx’ as in FIG. 8A, and the horizontal arrows below represent time. At a time t0, the base station (Tx) may sequentially transmit signals using multiple transmission beams to cover all directions of the base station. In other words, the base station (Tx) may transmit the beams in the order of the first transmission beam 801, the second transmission beam 802, and the third transmission beam 803. As illustrated in FIG. 8B, the directions of the first transmission beam 801, the second transmission beam 802, and the third transmission beam 803 may each be different beam directions. In other words, each beam transmitted by the base station (Tx) may have directivity. Additionally, each transmission beam may transmit an SSB. The order in which the beams are sequentially transmitted is illustrated through an arrow of reference numeral 810 as in FIG. 8A.

At a time t1 after one SSB transmission period has elapsed, the base station (Tx) may sequentially transmit transmission beams while using only some beams covering some directions among all directions, with each beam transmitting an SSB. For example, the base station may reduce the number of transmitted beams by transmitting only even-numbered beams (or odd-numbered beams). Referring to FIG. 8B, the base station transmits the first transmission beam 801, does not transmit the second transmission beam 802, and transmits the third transmission beam 803. In this case, the order of the sequentially transmitted beams may remain the same as that described in FIG. 8A.

At a time t2 after another SSB transmission period has elapsed, SSBs may be transmitted through transmission beams in the same manner as described for the time to. At a time t3, SSBs may again be transmitted through some of the transmission beams in the same manner as the transmission method at the time t1.

Meanwhile, in the example of FIG. 8B, a case is illustrated where SSBs are transmitted using even-numbered beams (or odd-numbered beams) when only some beams are used. However, this is not a limitation of the present disclosure. That is, the transmission may be configured differently depending on the level of subdivision of the beam width used for SSB transmission, such as in multiples of three or four. Additionally, an example is provided where the period alternates between SSB transmission using only some of the beams and SSB transmission using all of the beams. However, the frequency of SSB transmission using only some of the beams may be increased or decreased as needed.

### Second Method of the First Exemplary Embodiment

Compared to general SSB transmissions, the method according to the case of FIG. 8B described above may increase the degree of freedom in SSB transmission. Another method for increasing the degree of freedom is described below.

In order to increase the degree of freedom in SSB transmission, as in FIG. 8B, the base station may need to be able to transmit information on modified SSB transmission times and modified resource allocation information to the terminal. Therefore, the base station needs to be able to configure two SSB bursts. For example, the first SSB burst configured by the base station may be configured such that SSBs are transmitted in all possible directions during a first period, and the second SSB burst configured by the base station may be configured such that SSBs are transmitted only in some of possible directions during a second period.

For each of the first SSB burst and the second SSB burst, information on SSBs included in each burst may be delivered to the terminal using the ssb-PositionsInBurst field described in Table 1. Information on an additional second transmission periodicity may be provided to the terminal by adding an RRC parameter such as the ssb-PeriodicityServingCell field.

FIG. 8C is a conceptual diagram illustrating a case where a base station periodically transmits SSB according to the second method of the first exemplary embodiment of the present disclosure.

Referring to FIG. 8C, similarly to FIG. 8A, the base station may be represented as ‘Tx’, and the horizontal arrows below may indicate time. At a time t00, the base station (Tx) may sequentially transmit SSBs using multiple transmission beams to cover all directions of the base station. In other words, the base station (Tx) may transmit the beams in the order of the first transmission beam 801, the second transmission beam 802, and the third transmission beam 803. As illustrated in FIG. 8C, the directions of the first transmission beam 801, the second transmission beam 802, and the third transmission beam 803 may each be different beam directions. In other words, each beam transmitted by the base station (Tx) may have directivity. Additionally, each transmission beam may transmit an SSB. The order in which the beams are sequentially transmitted in FIG. 8C is illustrated through an arrow of reference numeral 810 as in FIG. 8A.

The SSB period in FIG. 8C may extend to a time t10. Accordingly, at the time t10, the base station (Tx) may transmit in the same order as at the time t00, that is, in the order of the first transmission beam, the second transmission beam, and the third transmission beam. In other words, the SSB period based on the time t00 may be the SSB period for the first SSB burst.

Meanwhile, in the present disclosure, a second SSB period for the second SSB burst may be added. As illustrated in FIG. 8C, a start time t01 of the second SSB period for the second SSB burst may begin at an arbitrary time between the time t00 and the time t10.

At the time t01 which is the start time of the second SSB period, the base station (Tx) may sequentially transmit using only some of the beams among all directions, as described in FIG. 8B. Each beam may also transmit an SSB. In FIG. 8C, for the beams transmitted in the second SSB period, an example is illustrated in which the base station reduces the number of transmission beams, such as using only even-numbered beams (or odd-numbered beams). Referring to FIG. 8C, an example is illustrated in which the base station transmits the first transmission beam 801, does not transmit the second transmission beam 802, and transmits the third transmission beam 803. In this case, the order in which the beams are transmitted sequentially may be the same as the order described in FIG. 8A. The second SSB period may be the same as the first SSB period. Therefore, at a time t11, the second SSB burst may be transmitted in the same manner as at the time t01.

### Third Method of the First Exemplary Embodiment

A terminal that has received the first SSB burst and the second SSB burst described in FIG. 8C needs to be able to distinguish between the transmission times and the respective SSB bursts. Accordingly, the base station may include additional identifier (ID) information within the SSB and transmit it so that the terminal can distinguish between the first SSB burst and the second SSB burst. Through this, the terminal may determine to which burst the currently received SSB belongs. Additionally, the base station may further adjust a transmission time of the SSB burst by adding offset information to the SSB periodicity information in the RRC parameter configuration.

FIG. 8D is a conceptual diagram illustrating a case where a base station periodically transmits SSBs according to the third method of the first exemplary embodiment of the present disclosure.

Comparing FIG. 8D with FIG. 8C, a difference lies in the presence of an SSB offset. In other words, while the second SSB burst should be transmitted at the time t01 as in FIG. 8C, if an SSB offset is used, the second SSB burst may be transmitted at a time t02, which is delayed by a time value based on the SSB offset. By configuring the transmission time of the second SSB burst to be delayed by the time value based on the SSB offset, the identification between the first SSB burst and the second SSB burst may be facilitated.

It should be noted that the first exemplary embodiment described above may be applied in combination with other exemplary embodiments described below as long as they do not conflict.

### Second Exemplary Embodiment

In the first exemplary embodiment described above, the method has been proposed to perform beam measurement for intelligent beam management while reducing RS overhead by utilizing the SSB transmission process. Hereinafter, a second exemplary embodiment is described for reducing unnecessary overhead.

In the second exemplary embodiment of the present disclosure, as described in FIG. 8A, SSB transmission may be performed according to the 5G NR technical specifications. As another example, as described in FIGS. 8B to 8D, the degree of freedom in SSB transmission may be increased according to the second exemplary embodiment of the present disclosure. The following describes a case in which CSI-RS is used for beam measurement.

According to the 5G NR technical specifications, CSI-RS resource allocation may be configured on a per-terminal basis. However, all terminals that use intelligent beam prediction operations based on AI/ML models need to periodically perform measurement operations on beams that may be used as inputs to the AI/ML models. Therefore, in the second exemplary embodiment of the present disclosure, cell-specific CSI-RS is introduced.

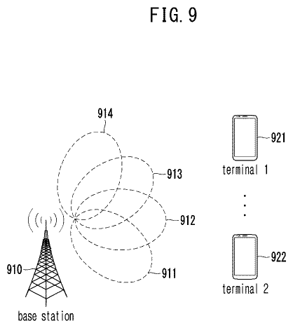

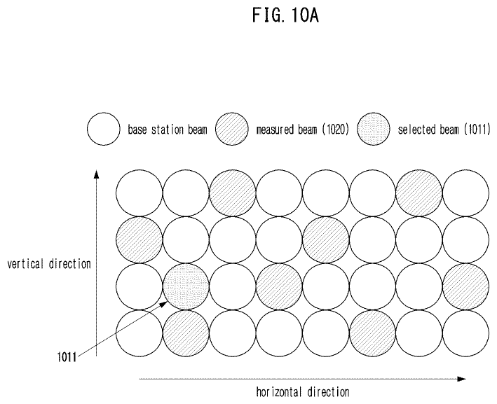

FIG. 9 is a conceptual diagram illustrating a case where a base station broadcasts cell-specific CSI-RSs to terminals according to the second exemplary embodiment of the present disclosure.

Referring to FIG. 9, a base station 910 and multiple terminals 921 and 922 are illustrated. The base station 910 may communicate with the terminals 921 and 922 within a specific cell. The base station 910 may broadcast cell-specific CSI-RSs using multiple beams 911, 912, 913, and 914 according to the present disclosure. In the present disclosure, the cell-specific CSI-RS may also be understood as cell-based CSI-RS. Accordingly, each of the terminals 921 and 922 may receive the cell-specific CSI-RS within the cell through multiple beams. In this case, the cell may refer to a specific bandwidth part (BWP). Therefore, the cell-specific CSI-RS may be configured for each specific BWP. Each of the terminals 921 and 922 may measure the transmission beams 911, 912, 913, and 914 transmitted by the base station based on the received cell-specific CSI-RS and thereby measure the channel. In other words, each of the terminals 921 and 922 may obtain beam performance information through the measurement of cell-specific CSI-RSs.

In the 5G NR communication system, the base station configures and transmits CSI-RS for each terminal. However, in the present disclosure, by allowing the base station 910 to broadcast the cell-specific CSI-RS, signaling overhead may be reduced compared to transmitting CSI-RS for each terminal.

A difference between the cell-based CSI-RS used in the intelligent beam management process and conventional CSI-RS is that, in the conventional method, the base station transmits RS configuration information to each terminal, and the terminal receives RSs configured for each terminal. In contrast, in the second exemplary embodiment of the present disclosure, the base station broadcasts a CSI-RS, and each terminal may receive the broadcast CSI-RS. Even terminals in the RRC idle state, not in the RRC-connected state, may receive the broadcast CSI-RS. Through this, beam measurement for intelligent beam management operations may be performed.

A method may be required for the terminal to distinguish between cell-based CSI-RS according to the second exemplary embodiment of the present disclosure and CSI-RS configured on a per-terminal basis. Accordingly, in the second exemplary embodiment of the present disclosure, the cell-based CSI-RS may be distinguished by adding a configuration field to a NZP-CSI-RS-ResourceSet IE, as shown in Table 2 below. For example, the additional field may be named CellSpecificIndicator. Although the CellSpecificIndicator field is not exemplified in Table 2 below, the CellSpecificIndicator field may be added to Table 2.

TABLE 2

```
NZP-CSI-RS-ResourceSet ::= SEQUENCE {
        nzp-CSI-ResourceSetId NZP-CSI-RS-ResourceSetId,
        nzp-CSI-RS-Resources SEQUENCE (SIZE (1..maxNrofNZP-CSI-RS-
ResourcesPerSet)) OF NZP-CSI-RS-ResourceId,
        repetition ENUMERATED { on, off }
        aperiodicTriggeringOffset INTEGER(0..6)
        trs-Info ENUMERATED {true}
        ...,
        [[
        aperiodicTriggeringOffset-r16 INTEGER(0..31)
      ]],
        [[
        pdc-Info-r17 ENUMERATED {true}
        cmrGroupingAndPairing-r17 CMRGroupingAndPairing-r17
        aperiodicTriggeringOffset-r17 INTEGER (0..124)
        aperiodicTriggeringOffsetL2-r17 INTEGER(0..31)
      ]]
}
```

When the configuration field is set to indicate that a configured CSI-RS is a cell-specific CSI-RS, as shown in Table 2, the terminal may recognize that the corresponding CSI-RS is to be used for intelligent beam management operations.

It should be noted that the second exemplary embodiment described above may be applied in combination with other exemplary embodiments described below as long as they do not conflict.

### Third Exemplary Embodiment

In the 5G NR system, one or more different antenna ports (or one or more channels) may have an associated relationship through a quasi-co-location (QCL) configuration. Specifically, the QCL configuration may associate two different antenna ports by defining a relationship between a target antenna port and a reference antenna port. The terminal may apply all or some of statistical characteristics of a channel measured at the reference antenna port when receiving at the target antenna port.

A transmission configuration indication (TCI)-state parameter (i.e. TCI-State), which is an RRC IE, may associate one or two reference signals with a corresponding QCL type. The TCI-state IE may be exemplified as shown in Table 3 below.

TABLE 3

```
TCI-State ::= SEQUENCE {
        tci-StateId TCI-StateId,
        qcl-Type1 QCL-Info,
        qcl-Type2 QCL-Info
        ...,
        [[
        additionalPCI-r17 AdditionalPCIIndex-r17
        pathlossReferenceRS-Id-r17 PathlossReferenceRS-Id-r17
        ul-powerControl-r17 Uplink-powerControlId-r17
        ]],
}
QCL-Info ::= SEQUENCE {
        cell ServCellIndex
        bwp-Id BWP-Id
        referenceSignal CHOICE {
          csi-rs NZP-CSI-RS-ResourceId,
          ssb SSB-Index
        },
        qcl-Type ENUMERATED {typeA, typeB, typeC, typeD},
        ...
}
```

As illustrated in Table 3, the base station may configure or indicate up to two QCL configurations (qcl-Type1, qcl-Type2) for a single target antenna port through a TCI state configuration. Among the two QCL configurations included in a single TCI state configuration, the first QCL configuration (qcl-Type1) may be configured as one of QCL-Type A (QCL-TypeA), QCL-Type B (QCL-TypeB), or QCL-Type C (QCL-TypeC). In this case, the configurable QCL types may be limited according to the type of the target antenna port and the reference antenna port. Additionally, among the two QCL configurations included in the TCI state configuration, the second QCL configuration (qcl-Type2) may only be configured as QCL-Type D (QCL-TypeD), and in some cases, the second QCL configuration (qcl-Type2) may be omitted.

The bandwidth part identifier (bwp-id) field may indicate a position of a DL BWP where the RS is located. The cell field may indicate a serving cell of the terminal for which the RS is configured. If this field does not exist, the TCI state is applied to a configured serving cell. The RS may be located in a serving cell different from the serving cell where the TCI state is configured only when the qcl-Type is configured as typeC or typeD. The referenceSignal field may indicate an identifier of the RS for which QCL information is provided.

The specific types of QCL are detailed in Table 4 below.

TABLE 4

| QCL type | Description |
|---|---|
| QCL-TypeA | Doppler shift, Doppler spread, Average delay, Delay spread |
| QCL-TypeB | Doppler shift, Doppler spread |
| QCL-TypeC | Doppler shift, Average delay |
| QCL-TypeD | Spatial Rx parameter |

QCL-Type A (QCL-TypeA), as exemplified in Table 4, may be used when a bandwidth and a transmission duration of the target antenna port are sufficient compared to the reference antenna port, allowing reference to all statistically measurable characteristics in both frequency and time domains.

QCL-Type B (QCL-TypeB), as exemplified in Table 4, may be a QCL type used when the bandwidth of the target antenna port is sufficient to measure statistical characteristics in the frequency domain.

QCL-Type C (QCL-TypeC), as exemplified in Table 4, may be used when the bandwidth and transmission duration of the target antenna port are insufficient to measure second-order statistics, such as Doppler spread and delay spread, and only first-order statistics may be referenced.

QCL-Type D (QCL-TypeD), as exemplified in Table 4, may be a QCL type configured when spatial reception filter values used for receiving the reference antenna port may be used when receiving the target antenna port.

Meanwhile, AI/ML models for intelligent beam prediction may be located at both the base station and the terminal. The intelligent beam prediction technique is a technique for predicting an optimal beam to be transmitted by the base station based on information on some measured beams among all beams that the base station can transmit. Since the intelligent beam prediction technique does not perform measurements on all beams, there is a possibility that the predicted optimal beam is not included in the measured beams. This may be described with reference to the attached drawings, which may include the following cases.

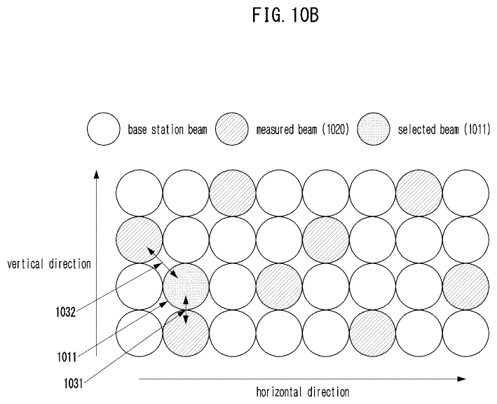

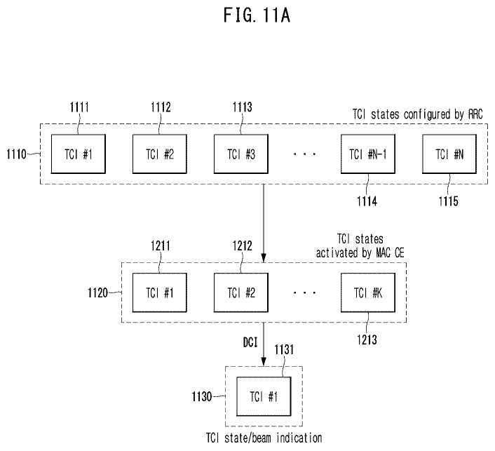

FIG. 10A is a conceptual diagram illustrating a case where a predicted beam is not included in a set of measured beams among beams that a base station can transmit.

Referring to FIG. 10A, each of circles may represent a beam that a base station can transmit. In FIG. 10A, an example is illustrated in which 8 beams in the horizontal direction are arranged across 4 layers in the vertical direction. However, it should be noted that the example in FIG. 10A is provided for ease of understanding and does not limit the number of beams that the base station can transmit to 32. For example, the number of beams that the base station can transmit may be greater than 32, such as 64 or 128, or smaller than 32, such as 24 or 16.

The example of FIG. 10A may assume a case where the number of beams that the base station can transmit is 32. Although the base station can transmit 32 beams, the base station may use measurement results for only 8 beams by employing an intelligent beam prediction model. In other words, the base station may transmit RS through only 8 beams to a terminal. The terminal may receive the RS through each of the 8 beams and measure the RS corresponding to the received beam, then report RS measurement information to the base station. Accordingly, the base station may select an optimal beam from among the entire 32 base station beams using only the measurement results of the 8 beams. If a beam other than the 8 measured beams is selected, the terminal may not have information regarding reception of the selected base station beam. In other words, as illustrated in FIG. 10A, if a selected beam 1011 is not included in the measured beams 1020, there may be no information regarding the selected beam 1011 at the base station.

As illustrated in FIG. 10A, when no information exists for the selected beam 1011, the base station may additionally transmit RS through the selected beam 1011 and receive a measurement report on the selected beam 1011 from the terminal. However, performing such additional procedure may result in additional overhead.

Accordingly, the third exemplary embodiment of the present disclosure proposes a method for inferring information on the selected beam 1011 when information on the selected beam 1011 is not available. According to the third exemplary embodiment of the present disclosure, the base station may notify the terminal of a QCL-TypeD configuration with a beam that is expected to have similar spatial reception parameters to the selected beam 1011 among the measured beams 1020 for which the terminal measured the RS. However, there may be cases where it is difficult to clearly represent the selected beam 1011, which is the result of intelligent beam prediction, using a QCL-TypeD configuration with only a single measured beam. If it is difficult to provide the terminal with accurate spatial reception information for the selected beam using only a QCL-TypeD configuration with a single reference signal, the base station may transmit QCL-TypeD information for multiple (two or more) reference signals (beams) to the terminal.

FIG. 10B is a conceptual diagram for describing a procedure for inferring information on a predicted beam when the predicted beam is not included in a set of measured beams among beams that a base station can transmit.

Referring to FIG. 10B, as described in FIG. 10A, each of circles may represent a beam that a base station can transmit. FIG. 10B illustrates an example where 8 beams in the horizontal direction are arranged across 4 layers in the vertical direction. The base station can transmit 32 beams, but by using an intelligent beam prediction model, the base station may utilize measurement results for only 8 beams. In other words, the base station may transmit RS to a terminal through only 8 beams. The terminal may receive the RS through each of the 8 beams and measure the RS corresponding to the received beam, then report RS measurement information to the base station. Accordingly, the base station may select an optimal beam from among the entire 32 beams of the base station using only the measurement results of the 8 beams.

As described in FIG. 10A, if the selected beam 1011 is not included in the measured beams 1020, the base station may not have information regarding the selected beam 1011. In such cases, as described above, the base station may configure a QCL-TypeD configuration with a beam among the measured beams 1020 that is expected to have similar spatial reception parameters to the selected beam 1011, and transmit the configuration to the terminal.

According to the example of FIG. 10B, the beam with spatial reception parameters similar to the selected beam 1011 may be the first beam 1031, which is the closest beam. Accordingly, the base station may configure a parameter of the first beam 1031 to QCL-TypeD, and transmit the configuration to the terminal.

According to the example of FIG. 10B, the spatial reception parameters in the horizontal direction for the first beam 1031 may be the same as those for the selected beam 1011, but the spatial reception parameters in the vertical direction for the first beam 1031 may be different from those for the selected beam 1011. Accordingly, the base station may additionally configure the spatial reception parameters of the second beam 1032, which is expected to have similar horizontal parameters to the selected beam 1011, to QCL-TypeD, and transmit the configuration to the terminal. In other words, the base station may configure both the first beam 1031 and the second beam 1032 with QCL-TypeD for the selected beam 1011 and transmit the configuration to the terminal. In this case, the base station may configure the first beam 1031 for the terminal to use the horizontal parameter among spatial reception parameters, and the second beam 1032 for the terminal to use the vertical parameter among spatial reception parameters.

When transmitting a TCI state IE to the terminal by using two or more beams for the selected beam 1011 as described above, an additional element may be included to represent QCL-TypeD information for the second beam 1032.

A first method for representing QCL-TypeD information for the second beam 1032 is to add qcl-TypeN (or qcl-Type3) to the TCI state IE, which may express a new QCL relationship. The added qcl-TypeN (or qcl-Type3) may be used to represent a new QCL-TypeD relationship.

A second method for representing QCL-TypeD information for the second beam 1032 is to allow the reference signal field of the QCL information (Info) field to include two or more reference signal indexes instead of only one index. By using the second method, the QCL-TypeD relationship may be expressed using the existing qcl-Type2 while representing multiple reference signals.

It should be noted that the third exemplary embodiment described above may be applied in combination with other exemplary embodiments described above and/or described below as long as they do not conflict.

### Fourth Exemplary Embodiment

An AI/ML model, which is an intelligent beam prediction model, may be located at both a terminal and a base station. When the intelligent model is located at the terminal, the terminal may predict a base station beam using beam measurement information. If specific information on the base station beam (e.g. beam angle) is not provided to the terminal due to proprietary information security concerns, the performance of the intelligent beam prediction model operating at the terminal may be degraded. In such a situation, the base station may restrict the beams that the intelligent model operating at the terminal can predict as outputs.

A TCI signaling mechanism may be used to restrict the output-predicted beams of the intelligent model. The TCI signaling mechanism in the 5G NR system varies depending on a target signal. A TCI for a CSI-RS may be provided through RRC signaling for periodic CSI-RS, through MAC-CE for semi-persistent CSI-RS, and through a combination of RRC, MAC-CE, and DCI for aperiodic CSI-RS.

The three TCI mechanisms exemplified above may be equally applied to a CSI-RS for CSI acquisition, CSI-RS for beam management (BM), and a tracking reference signal (TRS). For a PDCCH DMRS, a TCI may be provided as a combination of RRC and MAC-CE. For a PDSCH DMRS, a TCI may be provided as a combination of RRC, MAC-CE, and DCI. Specifically, according to the 5G NR technical specifications, the following signals are defined for selection of a PDSCH beam.

For higher-layer configuration, the terminal may utilize a tci-StatePDSCH parameter among UE capability parameters. The tci-StatePDSCH parameter may be used to define a TCI state for PDSCH transmission. The number of TCI states that may be configured using the tci-StatePDSCH parameter may be set to up to 128. Among the TCI states configured by the tci-StatePDSCH parameter, the base station may activate up to 8 TCI states through a MAC-CE message. A reason that the maximum number of TCI states configurable through a MAC-CE message is eight is that a three-bit TCI field included in DCI may distinguish 8 different cases. Accordingly, DCI may indicate one of the TCI states activated by the MAC-CE.

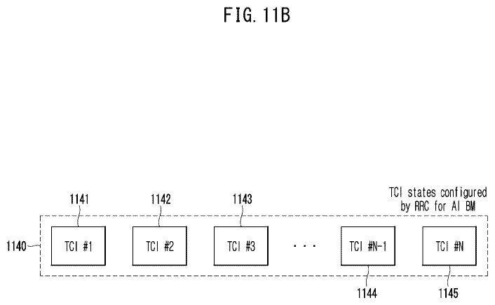

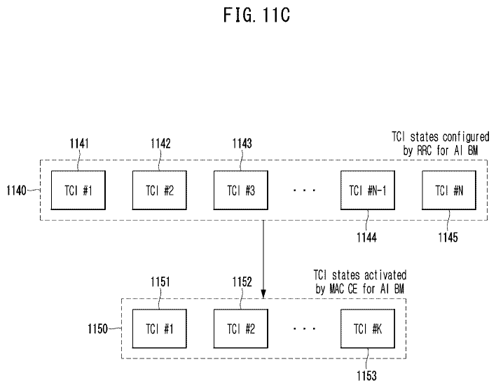

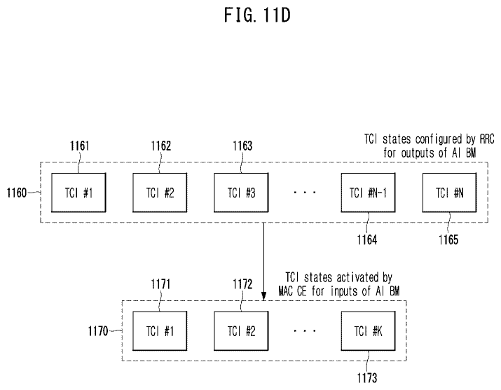

FIG. 11A is a conceptual diagram for describing a procedure in which one TCI is finally indicated to a terminal among TCIs configured by a base station.

The base station may configure TCI states 1111, 1112, 1113, . . . , 1114, and 1115 to the terminal through RRC signaling. In this case, the maximum number of TCI states that may be configured through RRC signaling may be up to 128, as described above. FIG. 11A illustrates an example where TCI states from TCI #1 to TCI #N are configured, where the maximum value of N may be up to 128. Thereafter, the base station may configure activated TCI states 1211, 1212, . . . , and 1213 through a MAC-CE. The maximum number of activated TCI states configurable through the MAC-CE may be 8. In the exemplary embodiment of FIG. 11A, the TCI #1 1211, TCI #2 1212, . . . , and TCI #K 1213 are exemplified.

To transmit a PDSCH to the terminal, the base station may transmit DCI 1130 on a PDCCH. In this case, the DCI 1130 may include a three-bit TCI field. The base station may indicate one of the TCI states activated through the MAC-CE using a codepoint of the TCI field included in the DCI. In the example of FIG. 11A, the TCI #1 1131 is illustrated as being indicated. Through the above-described procedure, the base station may configure a specific TCI state for the terminal using the TCI field included in the DCI.

Similarly to the mechanism described above, a parameter may be configured for defining TCI states of beams for intelligent beam prediction through a higher-layer configuration. For convenience of description in the present disclosure, the parameter for defining the TCI states of beams for intelligent beam prediction is referred to as a tci-StateAIBM parameter.

The base station may configure the tci-StateAIBM parameter to define the TCI states of beams for intelligent beam prediction. The base station may then transmit a message in which the tci-StateAIBM parameter is configured to the terminal. As described in FIG. 11A, the message may be transmitted by being included in an RRC signaling message.

FIG. 11B is a conceptual diagram for describing a case in which TCI states for AI BM are configured to a terminal through a tci-StateAIBM parameter of an RRC signaling message according to the first method of the third exemplary embodiment of the present disclosure.

As illustrated in FIG. 11B, the base station may configure TCI states 1141, 1142, 1143, . . . , 1144, and 1145 to the terminal using a tci-StateAIBM parameter 1140 added to an RRC signaling message. FIG. 11B illustrates the same TCI states as those described in FIG. 11A. In other words, up to 128 TCI states may be configured using the tci-StateAIBM parameter 1140 added to the RRC signaling message. However, the TCI states illustrated in FIG. 11B differ in that the TCI states are for AI BM. Accordingly, the terminal may be configured with the TCI states 1141, 1142, 1143, . . . , 1144, and 1145 using the tci-StateAIBM parameter 1140 added to the RRC signaling message transmitted by the base station. An intelligent model operating in the terminal may derive an output value among beams corresponding to the configured TCI states.

FIG. 11C is a conceptual diagram for describing a case in which TCI states for AI BM are configured to a terminal through a two-step configuration using RRC signaling and MAC CE according to the second method of the third exemplary embodiment of the present disclosure.

Referring to FIG. 11C, as described in FIG. 11B, the base station may configure TCI states 1141, 1142, 1143, . . . , 1144, and 1145 to the terminal using the tci-StateAIBM parameter 1140 added to the RRC signaling message. In other words, the same reference numerals may refer to the same contents and the same operations.

Additionally, the base station may configure K TCI states 1151, 1152, . . . , and 1153, which the terminal can output using intelligent beam prediction in a current situation, using a MAC CE message 1150 as needed.

When the TCI states are configured in two steps as illustrated in FIG. 11C, the TCI states configured through the first RRC signaling may be used as input beams for the intelligent model located in the terminal. The base station may not need to restrict input beams of the intelligent model located in the terminal. However, since the base station is an entity transmitting RSs, the base station may configure, through the RRC signal, TCI states associated with the RSs that the base station is transmitting or planning to transmit to the terminal.

FIG. 11D is a conceptual diagram for describing a case in which TCI states for AI BM are configured to a terminal through a two-step configuration using RRC signaling and MAC CE according to the third method of the third exemplary embodiment of the present disclosure.

Referring to FIG. 11D, a specific parameter of an RRC signaling message may be used to configure outputs of AI BM. As the specific parameter, the tci-StateAIBM parameter 1140 described in FIG. 11B may be used or a new parameter may be added. A difference between the tci-StateAIBM parameter 1140 configured in FIG. 11B and the parameter illustrated in FIG. 11D is that an RRC message parameter 1160 indicates TCI state configured for outputs of AI BM, which includes TCI states 1161, 1162, 1163, . . . , 1164, and 1165.

According to the exemplary embodiment illustrated in FIG. 11D, a MAC CE 1170 is used as described in FIG. 11C. However, unlike FIG. 11C, activated TCI states 1171, 1172, . . . , and 1173 for inputs of AI BM may be configured. The exemplary embodiment of FIG. 11D illustrates that some beams among the output beams configured through the specific parameter 1160 of the RRC signaling message may be selected to configure input beams for the intelligent model used in the inference process. For example, through the specific parameter 1160 of the RRC signaling message, output information (e.g. TCI states) of the intelligent model may be first configured, and then MAC CE 1170 may be used to select, among the output beams, input beams associated with RS transmission of the base station.

It should be noted that the fourth exemplary embodiment described above may be applied together with other exemplary embodiments described above and/or below as long as they do not conflict.

### Modified Exemplary Embodiment from the Fourth Exemplary Embodiment

As described in the fourth exemplary embodiment, when an intelligent model is located in a terminal, a base station may need to deliver information on input beams and output beams of the intelligent model to the terminal. The fourth exemplary embodiment described above proposed the method of configuring such information through RRC signaling and MAC CE signaling. However, it may also be possible for the base station to inform such information to the terminal by configuring a CSI resource set.

A CSI resource set may be configured with CSI-RS(s) or SSB(s), and a CSI-RS resource may be indicated using a CRI, while an SSB resource may be indicated using an SSBRI. The base station may configure separate CSI resource sets for beams corresponding to the input of the intelligent model and for beams corresponding to the output of the intelligent model. The base station may then transmit information on the CSI resource sets, including identifiers corresponding to the input and output of the intelligent model, to the terminal.

When the terminal receives the information on the CSI resource sets from the base station, the terminal may identify (or recognize or determine) the CSI resource sets corresponding to the input and output of the intelligent model based on the information on the CSI resource sets.

Meanwhile, when the intelligent model is trained in the terminal, not all beams corresponding to the input provided by the base station may be used. Accordingly, if the intelligent model currently used by the terminal does not utilize all of the configured input beams, the terminal may transmit information on the currently used input beams (or information on unused input beams) to the base station. The base station that has received information on the input beams used (or unused) in the intelligent model may configure (or control) RS transmission so that RSs are not transmitted through the beams unused in the intelligent model. If the base station determines, based on information regarding the inputs of intelligent models used by terminals within a cell, that transmitting all RSs corresponding to these inputs is unnecessary during the inference process, the base station may omit the transmission of unnecessary RSs.

It should be noted that the modified exemplary embodiment of the fourth exemplary embodiment described above may be applied together with other exemplary embodiments described above and/or below as long as they do not conflict.

### Fifth Exemplary Embodiment

For intelligent beam management operations, a process of delivering L1-RSRP values or other necessary input or output values of an intelligent model from a terminal to a base station is required. In the 5G NR system, beam measurement and reporting for beam management are specified to use CSI reporting. The general process of CSI reporting by a terminal will be described with reference to the attached drawings.

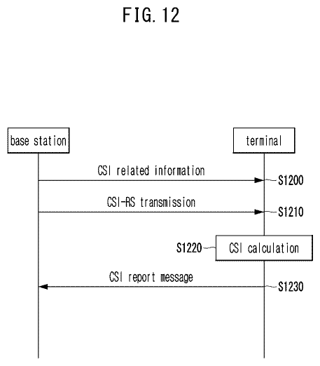

FIG. 12 is a sequence chart illustrating transmission of CSI-RS configuration information, CSI-RS measurement, and CSI reporting.

In step S1200, the base station may transmit CSI-related information, including CSI-RS resource configuration information, to the terminal. Accordingly, in step S1200, the terminal may receive the CSI-related information from the base station.

In step S1210, the base station may generate CSI-RS(s) based on the CSI resource configuration information, and transmit the generated CSI-RS(s) to the terminal through respective beams. Additionally, in step S1210, the terminal may receive the CSI-RS(s) from the base station based on the previously received CSI-related information. In other words, the terminal may receive the CSI-RS(s) transmitted through each of base station beams.

In step S1220, the terminal may calculate CSI according to the CSI configuration received in step S1200. Here, CSI calculation may refer to generation of CSI based on the measurement of CSI-RS.

In step S1230, the terminal may transmit a CSI report message to the base station based on the calculated (or generated) CSI. Accordingly, in step S1230, the base station may receive the CSI report message from the terminal.

The operations described in FIG. 12 may be performed when an intelligent beam management model is present in the base station. For example, when the intelligent model for intelligent beam management is located in the base station, the terminal needs to report the values used as inputs for the intelligent model to the base station. To this end, in step S1230, the terminal may transmit the CSI report message including values used as inputs for the intelligent model to the base station.

First, a data collection procedure for the intelligent model will be considered. The data collection procedure may be a procedure in which input data for the AI/ML model, which is the intelligent model, is collected. Since data generation for the intelligent model is necessary in the data collection procedure, the terminal may need to report measurement values (e.g. L1-RSRPs) for all base station beams that the base station can transmit to the base station. According to the current 5G NR technical specifications, the terminal cannot report L1-RSRP information for more than four beams at once in the CSI reporting procedure for L1-RSRP. Therefore, in order for the terminal to report L1-RSRP information for more than four beams to the base station, modifications to the CSI report message may be required. However, if the terminal reports L1-RSRP information for all beams that the base station can transmit, a problem of excessive payload size may arise.

Accordingly, in the data collection procedure, the base station may limit the maximum number of L1-RSRP values that the terminal can transmit through a CSI report to K. The information on the restricted maximum number of L1-RSRP values may be configured in the CSI-related information configuration procedure. In other words, this may be preconfigured in step S1200.

As another method, in the data collection procedure, the base station may specify an L1-RSRP threshold that the terminal uses to perform L1-RSRP reporting. The L1-RSRP threshold may be included in the CSI-related information in step S1200 and may be pre-transmitted from the base station to the terminal. The terminal may transmit only L1-RSRP value(s) of beam(s) with values greater than the L1-RSRP threshold set by the base station.

The base station may apply the two methods described above together, such that the number of beams exceeding the L1-RSRP threshold does not exceed K.

When the intelligent model is located in the base station, in a manner similar to the data collection procedure, the base station may request L1-RSRP information from the terminal to use as inputs for the intelligent model during an inference procedure or a performance monitoring procedure. The L1-RSRP-related information to be used as inputs for the intelligent model may also be pre-transmitted from the base station to the terminal by being included in the CSI-related information in step S1200. As described above, in the data collection procedure, information on all beams of the base station may be required. However, a difference is that in the inference procedure or the performance monitoring of the intelligent model, information on only some beams may be needed. These beams may be a subset of all beams of the base station, selected for measurement, as described in FIG. 10A.

In the inference procedure or the performance monitoring of the intelligent model, the payload size of the CSI report message transmission described in FIG. 12 may be limited. As described above, the maximum number of L1-RSRP values that the terminal can transmit to the base station and/or the L1-RSRP threshold may be configured through the CSI-related information in step S1200. The maximum number of L1-RSRP values and/or the L1-RSRP threshold may be the same as those used in the data collection procedure or may be set to different values.

When an AI/ML model, which is an intelligent model for intelligent beam management, is located in the terminal, values corresponding to outputs of the intelligent model need to be transmitted from the terminal to the base station. When the intelligent model is located in the terminal, procedures different from those in which the intelligent model is located in the base station may be performed.

For example, when the intelligent model is located in the terminal, the base station may transmit RSs to the terminal during the data collection procedure, and the terminal may receive the RSs from the base station without separately reporting measurement values of them to the base station. The case where the intelligent model is located in the terminal will be described by taking the example of FIG. 12. In step S1200, the base station may transmit CSI-related information, including CSI resource configuration information, to the terminal. Additionally, the CSI-related information may include not only the CSI resource configuration information but also CSI reporting-related information. In step S1210, the base station may transmit CSI-RSs to the terminal based on the CSI resource configuration information. Accordingly, in step S1210, the terminal may receive and measure the CSI-RSs based on the CSI resource configuration information. In step S1220, the terminal may use the AI/ML model, which is the intelligent model, to measure the CSI-RSs and autonomously perform beam measurement. That the terminal autonomously performs beam measurement may be understood as generating beam measurement information. Since the intelligent model is located in the terminal and the data collection procedure is performed in the terminal, the terminal may transmit a CSI report message set to ‘No report’ to the base station in step S1230.

On the other hand, when performing the inference procedure of the intelligent model located in the terminal or when conducting performance monitoring of the intelligent model located in the terminal, the terminal needs to report output results of the intelligent model to the base station. Accordingly, in the inference procedure of the intelligent model located in the terminal or in the performance monitoring procedure of the intelligent model located in the terminal, the terminal may report the output results of the intelligent model to the base station through a CSI report message.

When the intelligent model is located in the terminal, the report message transmitted by the terminal to the base station in the data collection procedure and/or the report message in the inference procedure of the intelligent model located in the terminal or the performance monitoring procedure of the intelligent model located in the terminal may include a parameter indicating that the information is generated by the intelligent model.

Generally, the output of the intelligent model may be a predicted beam index (CRI or SSBRI) or L1-RSRP values of beams including the corresponding beam. A CSI report configuration may define the contents of the CSI report. A combination of reportable CSI parameters in the CSI report may be configured using a reportQuantity parameter.

First, information needs to be defined such that both the base station and the terminal can recognize that the values reported by the terminal to the base station through the CSI report message are output values of the intelligent model. To this end, a new reportQuantity parameter for CSI reporting of the intelligent beam management function may be defined, or a field indicating whether the intelligent beam management function is performed may be added to the currently used reportQuantity parameter.

When the output value of the intelligent model is a predicted beam index, L1-RSRP values for the beam(s) included in the CSI report message may not be configured. In other words, the CSI report message transmitted to the base station may include only the predicted beam index. In this case, since the current 5G NR technical specifications do not define a format of the reportQuantity parameter that allows transmission of only a beam index, a new format supporting this functionality is required.

Additionally, when the CSI report message includes L1-RSRP values, the CSI reporting may be performed using a cri-RSRP or ssb-Index-RSRP format of the reportQuantity parameter according to the current 5G NR technical specifications. However, in this case, when multiple L1-RSRP values are included and transmitted, it may be necessary to distinguish between the values predicted using the intelligent model and the values measured through actual beam measurement. Accordingly, a separate bit or a separate field may be used to indicate that the values are output values of the intelligent model.

The L1-RSRP information used in the above description may be an L1-RSRP value actually measured by the terminal through the RS transmission of the base station, or it may be an L1-RSRP value predicted by the intelligent model. Accordingly, the CSI report message according to the present disclosure may include an indicator configured to distinguish whether the L1-RSRP value is an actually measured value or a predicted value, depending on the needs of the base station.

It should be noted that the fifth exemplary embodiment described above may be applied together with other exemplary embodiments described above and/or below as long as they do not conflict.

### Modified Exemplary Embodiment 1 from the Fifth Exemplary Embodiment

When a temporal-domain beam prediction technique is used in intelligent beam management, modifications to the CSI reporting are required. First, when an intelligent model is located in a terminal, values corresponding to outputs of the intelligent model need to be transmitted from the terminal to a base station in an inference procedure. According to the current 5G NR technical specifications, a CSI report message may only be composed of a beam index for a single time instance and an L1-RSRP value corresponding to the beam index. Accordingly, to support temporal-domain beam prediction, information corresponding to multiple time instances needs to be included in a single CSI report message.

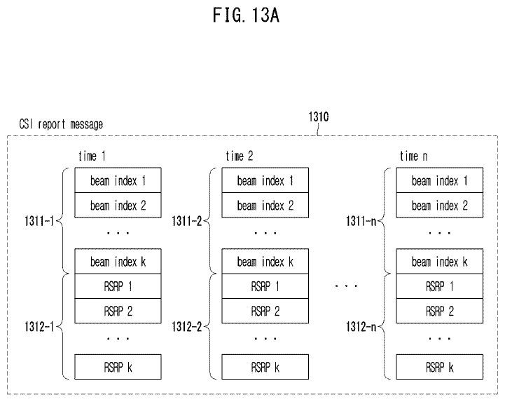

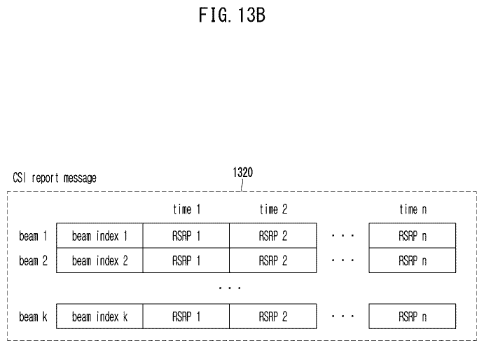

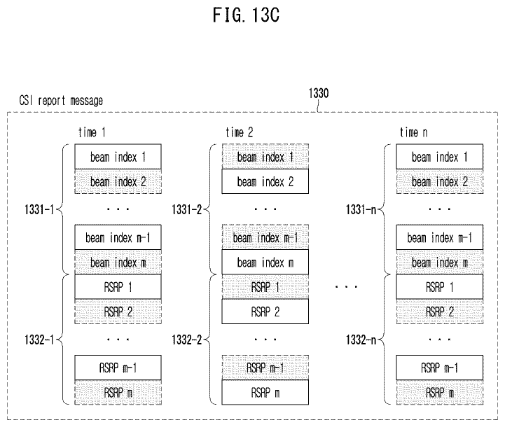

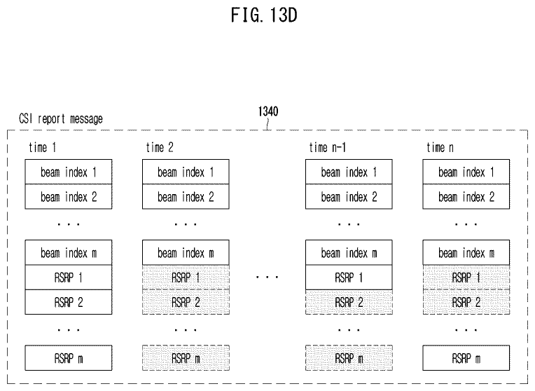

FIG. 13A is a conceptual diagram for describing a first method in which beam prediction information for multiple time domains is included in a single CSI report message when an intelligent model is located in a terminal.

A CSI report message 1310 illustrated in FIG. 13A exemplifies a case where beam indexes and predicted RSRP values corresponding to respective beams are included for multiple time instances. More specifically, the time instances may be distinguished into two or more instances, such as time 1, time 2, . . . , and time n.

CSI for the time 1 may include beam indexes 1311-1 and predicted RSRP values 1312-1 corresponding to the respective beams. The beam indexes 1311-1 may be beams inferred or predicted by the intelligent model located in the terminal, and FIG. 13A exemplifies a case where beam indexes 1, 2, . . . , and k are configured. The predicted RSRP values 1312-1 corresponding to the respective beams may include an RSRP 1 corresponding to the beam index 1, an RSRP 2 corresponding to the beam index 2, . . . , and an RSRP k corresponding to the beam index k.

CSI for the time 2 may include beam indexes 1311-2 and predicted RSRP values 1312-2 corresponding to the respective beams. The beam indexes 1311-2 for the time 2, as illustrated in FIG. 13A, may be the same as the beam indexes 1311-1 for the time 1. Accordingly, the predicted RSRP values 1312-2 for the time 2 may be predicted RSRP values respectively corresponding to the beam indexes 1311-2.

Similarly, the CSI for the time n may include beam indexes 1311-n and predicted RSRP values 1312-n corresponding to the respective beams. The beam indexes 1311-n for the time n, as illustrated in FIG. 13A, may be the same as the beam indexes 1311-1 for the time 1. Accordingly, the predicted RSRP values 1312-n for the time n may be predicted RSRP values respectively corresponding to the beam indexes 1311-n.

In FIG. 13A, the RSRP values corresponding to the respective beam indexes for the time 1 may be values based on inference by the intelligent model. The RSRP values corresponding to the respective beam indexes for the time 2 and subsequent time instances may also be values based on inference by the intelligent model. If the RSRP values corresponding to the respective beam indexes for the time 1 are values based on prediction by the intelligent model, the RSRP values corresponding to the respective beam indexes for the time 2 and subsequent time instances may also be values based on prediction by the intelligent model. In the following description of the present disclosure, examples related to inference may be described in the context of an intelligent model designed for inference. Accordingly, if the intelligent model is designed for prediction, the term ‘inference’ may be understood as being replaced with ‘prediction’.

The CSI report message 1310 illustrated in FIG. 13A may include inferred and/or predicted RSRP values for k beam indexes for each time instance, such as time 1, time 2, . . . , and time n. In this case, the inferred and/or predicted RSRP values may be expressed as absolute values in dBm.

As another method of expressing RSRP values, the RSRP values may be expressed as differences from a reference RSRP value. For example, the RSRP 1 predicted for the time 1 may be expressed as an absolute value, while the remaining predicted RSRP values—specifically, predicted RSRP 2 through predicted RSRP k—may be expressed as differences from the predicted RSRP 1. If the predicted RSRP 1 for the time 1 is expressed as an absolute value and the remaining predicted RSRP values are expressed as differences from the predicted RSRP 1, the same method may be applied for other time instances.

As another example of expressing predicted RSRP values, all inferred RSRP values for the first time instance may be expressed as absolute values, and predicted RSRP values for subsequent time instances may be expressed as differences from the corresponding predicted RSRP values for the first time instance.

FIG. 13B is a conceptual diagram for describing a second method in which beam prediction information for multiple time domains is included in a single CSI report when an intelligent model is located in a terminal.

Referring to FIG. 13B, a CSI report message 1320 transmitted by the terminal to the base station is illustrated. The CSI report message 1320 may be configured by selecting k optimal beams considering multiple time instances and allocating beam indexes to the respective beams. The terminal may map predicted RSRP information for each beam index at time 1, time 2, . . . , and time n to configure the CSI report message 1320.

The predicted RSRP values for each time instance included in the CSI report message 1320 may be expressed as absolute values in dBm. Alternatively, the predicted RSRP values for each time instance included in the CSI report message 1320 may be expressed as differences from a reference predicted RSRP value. For example, for each reported beam, the predicted RSRP value for the time 1 may be expressed as an absolute value in dBm, and the predicted RSRP values for subsequent time instances (time 2, . . . , time n) may be expressed as differences from the predicted RSRP value for the time 1.

It should be noted that the modified exemplary embodiment 1 of the fifth exemplary embodiment described above may be applied together with other exemplary embodiments described above and/or below as long as they do not conflict.

### Modified Exemplary Embodiment 2 of the Fifth Exemplary Embodiment

When a temporal-domain beam prediction technique is used in intelligent beam management, modifications to CSI reporting are required. When an intelligent model is located in a base station (or network), a process of transmitting beam measurement information from a terminal to the base station is necessary during data collection for training or during inference procedures. According to the current 5G NR technical specifications, a CSI report may only include a beam index for a single time instance and the corresponding L1-RSRP value. Therefore, to support temporal-domain beam prediction, information corresponding to multiple time instances needs to be included in a single CSI report.

However, when an intelligent model is located in a base station, not only k beams determined as an inference result but also measurement information of all beams may need to be transmitted, which may increase signaling overhead. Therefore, a method to reduce the overhead of beam measurement results transmitted by the terminal to the base station may be required.

FIG. 13C is a conceptual diagram for describing a first method in which beam measurement information for multiple time domains is included in a single CSI report when an intelligent model is located in a base station.

FIG. 13C illustrates a structure of a CSI report message 1330 when an intelligent model is located in a base station. The CSI report message 1330 may include beam indexes and the corresponding measured RSRP values for multiple time instances. As described above, reporting measured RSRP values for all beams may increase overhead. To reduce this, the terminal may report only a subset of the measured RSRP values based on a predefined rule.

According to the example in FIG. 13C, for a time 1, the CSI report message 1330 may include m beam indexes 1331-1, from a beam index 1 to a beam index m, and measured RSRP values 1332-1 corresponding to the respective beam indexes. In this case, as illustrated in FIG. 13C, odd-numbered beam indexes and the corresponding RSRP values may be included in the CSI report message 1330, while even-numbered beam indexes and the corresponding RSRP values may be excluded from the CSI report message 1330 based on a predefined rule.

Similarly, for a time 2, the CSI report message 1330 may include m beam indexes 1331-2, from the beam index 1 to the beam index m, and measured RSRP values 1332-2 corresponding to the respective beam indexes. In this case, as illustrated in FIG. 13C, even-numbered beam indexes and the corresponding RSRP values may be included in the CSI report message 1330, while odd-numbered beam indexes and the corresponding RSRP values may be excluded from the CSI report message 1330 based on a predefined rule.

The example in FIG. 13C corresponds a case where a time n is an odd-numbered instance. Accordingly, for the time n, the CSI report message 1330 may include odd-numbered beam indexes 1331-n and the corresponding RSRP values 1332-n, while even-numbered beam indexes and the corresponding RSRP values may be excluded from the CSI report message 1330 based on a predefined rule.

By alternating the transmission of measurement results for the respective beams, the overhead may be reduced. Additionally, since the measurement results are alternately included in the CSI report message 1330, missing RSRP values at certain time instances may be inferred and utilized.

As a variation of FIG. 13C, a predefined number of measured beam results may be reported for each time instance. For example, if the base station configures the CSI report message 1330 to include only c beam measurement results for each time instance, the terminal may select c beams with the highest RSRP values among m measurement results and include only those in the CSI report message 1330. The terminal may then transmit the CSI report message 1330 to the base station.

FIG. 13D is a conceptual diagram for describing a second method in which beam measurement information for multiple time domains is included in a single CSI report when an intelligent model is located in a base station.

Referring to FIG. 13D, a CSI report message 1340 may represent a case in which RSRP values measured according to temporal changes are transmitted, as described in FIG. 13C. In the example of FIG. 13D, for a time 1, all m beam indexes and measured RSRP values corresponding to all m beam indexes may be included in the CSI report message. From a time 2 onward, measured RSRP values may be included or omitted in the CSI report message based on changes in RSRP values relative to the values for the time 1. For example, if a change in the RSRP value reported for a newly added time instance relative to the RSRP value reported for a previous instance is within a predefined threshold, the reporting of the RSRP value may be omitted. In this case, information on beam index(es) may be transmitted to the base station to indicate that information on beam(s) corresponding the beam index(es) is included in the CSI report.

If the number of beam indexes is promised (or configured) between the base station and the terminal, the information on the beam index(es) information may also be omitted.

According to the example in FIG. 13D, all RSRP values corresponding to all beams for a time 2 may remain within the predefined threshold relative to the RSRP values for the time 1. Additionally, a difference between an RSRP 1 corresponding to a beam index 1 for a time n−1 and an RSRP value for a time n−2 (not illustrated in FIG. 13D) exceeds the predefined threshold. Similarly, in the example of FIG. 13D, a difference between an RSRP m corresponding to a beam index m for a time n and an RSRP value for the time n−1 may exceed the predefined threshold.

It should be noted that the modified exemplary embodiment 2 of the fifth exemplary embodiment described above may be applied together with other exemplary embodiments described above and/or below as long as they do not conflict.

### Sixth Exemplary Embodiment

When using an intelligent model, ensuring consistency of performance during a training procedure and an inference procedure of the intelligent model is essential. In other words, performance consistency means that an intelligent model trained in a specific environment should maintain the same performance in an environment where the inference operation is performed.

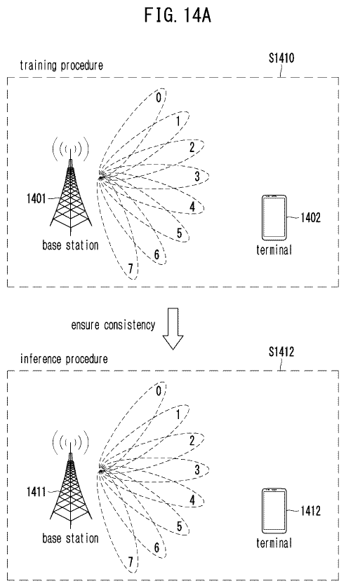

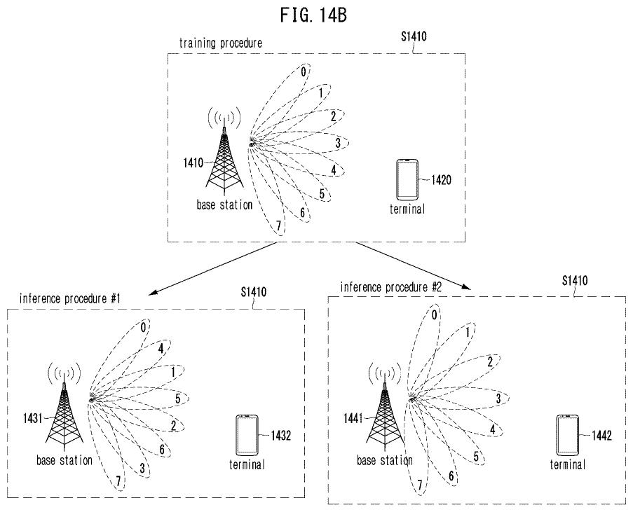

FIG. 14A is a conceptual diagram for describing a case where performance consistency is maintained during training and inference procedures of an intelligent model using a beam utilization example.

Referring to FIG. 14A, a training procedure of an intelligent model in step S1410 and an inference procedure of the intelligent model in step S1412 are illustrated. A base station 1401 in the training procedure of the intelligent model and a base station 1411 in the inference procedure of the intelligent model may be the same base station. However, different reference numerals are used for identification purposes. However, the base station 1401 in the training procedure of the intelligent model and the base station 1411 in the inference procedure of the intelligent model may be different base stations. Similarly, a terminal 1402 in the training procedure of the intelligent model and a terminal 1412 in the inference procedure of the intelligent model may be the same terminal. However, different reference numerals are used for identification purposes. The terminal 1402 in the training procedure of the intelligent model and the terminal 1412 in the inference procedure of the intelligent model may be different terminals.

In the training procedure of step S1410, the base station 1401 may transmit RSs to the terminal using transmission beams (Tx beams), and the terminal may receive the RSs. The terminal may measure the received RSs. Based on the measurement of the RSs, the terminal may report CSI to the base station using one of the methods described above. Through this process, the intelligent model located in the base station and/or the intelligent model located in the terminal may be trained. In this case, a pattern of the beams transmitted by the base station 1401 and beam indexing for delivering the patten to the terminal 1402 may be configured as illustrated in FIG. 14A.

In the inference procedure of step S1412, the base station 1411 may transmit RSs to the terminal 1412 using transmission beams (Tx beams), and terminal 1412 may receive the RSs. The terminal 1412 may measure the received RSs. Based on the measurements of the RSs, the terminal 1412 may report CSI to the base station 1411 using one of the methods described above. Through this process, the base station 1411 or the intelligent model included in the base station 1411 may infer beam performance for communication with terminal 1412. In this case, a pattern of the beams transmitted by the base station 1401 and beam indexing for delivering the patten to the terminal 1402 may be the same as those configured in the training procedure, as illustrated in FIG. 14A.

According to the example illustrated in FIG. 14A, there is no change in the pattern of transmission beams of the base station and the beam indexing for delivering the pattern to the terminal between the training and inference procedures. In other words, this represents an example in which consistency of the pattern of transmission beams of the base station is ensured between the training and inference procedures.

When the intelligent model is located in the base station 1401 or 1411, the base station 1401 or 1411 is aware of the currently transmitted beams of the base station, so consistency issues may not arise. However, when an intelligent model is located in the terminal 1402 or 1412, consistency issues may occur due to changes in the beams of the base station.

FIG. 14B is a conceptual diagram for describing a case where performance consistency is not maintained between training and inference procedures of an intelligent model using a beam utilization example.

The training procedure of step S1410 in FIG. 14B may be the same as the training procedure described in FIG. 14A. Therefore, a redundant description is omitted. FIG. 14B illustrates a case where an intelligent model is located in the terminal and where consistency is not maintained due to changes in beams of the base station from the training procedure of step S1410.

In other words, the beams of the base station may be changed as in an inference procedure #1 of step S1430 or an inference procedure #2 of step S1440.

More specifically, in the inference procedure #1 of step S1430, the base station 1431 may configure indexes of the beams transmitted to the terminal 1432 differently from those in the training procedure of step S1410. If the beam indexes of the base station in the training procedure and the beam indexes of the base station in the inference procedure #1 are different, performance consistency of the intelligent model may not be ensured.

More specifically, in the inference procedure #2 of step S1440, the indexes of the beams transmitted from the base station 1441 to the terminal 1442 may be the same as those in the training procedure, but the beam pattern may be changed. If the beam pattern of the base station in the training procedure and the beam pattern of the base station in the inference procedure #2 are different, performance consistency of the intelligent model may not be ensured.

In cases such as the inference procedure #1 or inference procedure #2, the terminal 1432 or 1442 may need to perform a new training process for the intelligent model according to a current situation of beams of the base station, or need to receive a new intelligent model suitable for the current situation from a terminal-side server or the base station.

However, since changes in the beam pattern of the base station or indexing that disrupt consistency in the intelligent beam management process are caused by the base station, the base station may recognize its own environmental changes. Additionally, the base station generally does not frequently change the beam pattern of the base station within a short period of time once a specific beam pattern is configured. Accordingly, the base station may share the current base station beam conditions with terminals using a specific ID (e.g. an association ID, a configuration ID, a dataset ID, etc.). More specifically, an example related to an association ID among IDs associated with the intelligent model in the terminal will be described. A configuration ID and/or dataset ID may be understood or applied in the same manner as the association ID described in the present disclosure. The base station may provide a specific ID to the terminal through higher-layer signaling, MAC-CE, or other methods.

For example, if an intelligent model has been trained in a state where an association ID is set to ‘1’, and the terminal can identify that a current base station beam pattern also has an association ID of ‘1’ when performing an inference procedure, performance consistency between the training procedure and the inference procedure of the intelligent model may be ensured.

It should be noted that the sixth exemplary embodiment described above may be applied together with other exemplary embodiments described above and/or below as long as they do not conflict.

### Seventh Exemplary Embodiment

The content described in the sixth exemplary embodiment above may function properly when operating within a specific cell (or local cell). However, when a terminal performs an intelligent beam management operation while moving across multiple cells, consistency may not be ensured because each cell may have a different beam pattern and a different beam indexing.

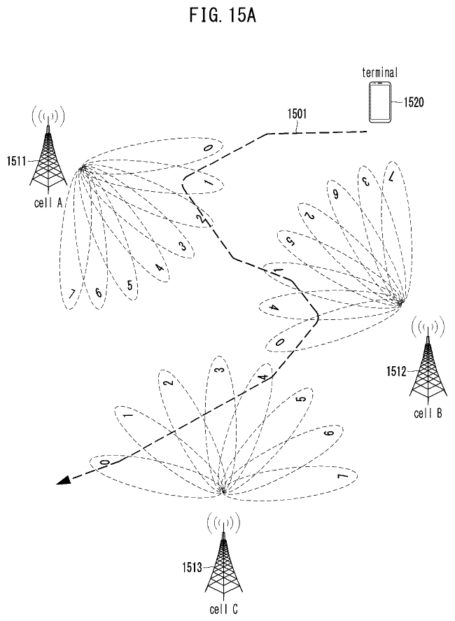

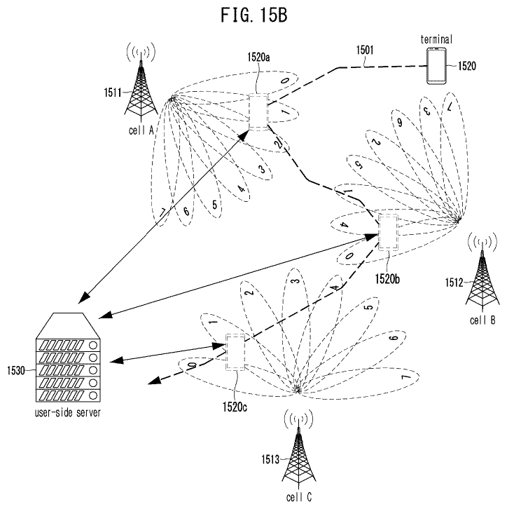

FIG. 15A is a conceptual diagram for describing a case where performance consistency is not maintained between a training procedure and an inference procedure when a terminal with an intelligent model moves across multiple cells.

Referring to FIG. 15A, a cell A 1511, a cell B 1512, and a cell C 1513 may form beams at different locations. Additionally, a terminal 1520 is assumed to move along a movement path 1501, indicated by a dotted line, in the order of the cell A 1511->cell B 1512->cell C 1513.

When the terminal 1520 is located within the cell A 1511, it is assumed that an association ID of the cell A is set to ‘2’, and it is also assumed that an association ID of the cell B 1512 is set to’ ‘1’ and that an association ID of the cell C 1513 is set to ‘2’.

Under the above-described assumption, the cell A 1511 and the cell C 1513 may have the same association ID of ‘2’. However, as illustrated in FIG. 15A, a beam pattern of the cell A 1511 and a beam pattern of the cell C 1513 may differ. Furthermore, since the cell B 1512 is configured with the association ID of ‘1’, it may have a different association ID from the cell A 1511. Consequently, the terminal 1520 may not be able to perform inference using the intelligent model stored in the terminal 1520 while moving between the cell A 1511, the cell B 1512, and the cell C 1513. In other words, since the beam indexing differs between the cell A 1511 and the cell B 1512, and the beam pattern differs between the cell A 1511 and the cell C 1513, and/or between the cell B 1512 and the cell C 1513, intelligent beam management operations using the intelligent model may not be feasible.

The present disclosure proposes the following method to address the issue illustrated in FIG. 15A.

A vendor of terminal 1520 may deliver an intelligent model to terminal 1520 in real time from a terminal-side server (or an OTT server) using location information or cell ID of the terminal 1520.

FIG. 15B is a conceptual diagram for describing a case in which an intelligent model is provided to a terminal in real time as the terminal moves across multiple cells according to the seventh exemplary embodiment of the present disclosure.

Referring to FIG. 15B, the cell A 1511, the cell B 1512, and the cell C 1513 are illustrated as forming beams at different locations. Additionally, the terminal 1520 is assumed to move along the movement path 1501, indicated by a dotted line, in the order of the cell A 1511→the cell B 1512→the cell C 1513.

In FIG. 15B, the terminal 1520 is identified as a terminal 1520a when communicating in the cell A 1511, a terminal 1520b when communicating in the cell B 1512, and a terminal 1520c when communicating in the cell C 1513.

Additionally, as illustrated in FIG. 15B, a user-side server 1530 may monitor the location of the terminal 1520 or an ID of a cell with which the terminal 1520 is communicating in real time. Based on the monitoring of the location and/or cell ID of the terminal 1520, the user-side server 1530 may continuously transfer an appropriate intelligent model to the terminal 1520. For example, when the terminal 1520 is communicating in the cell A 1511, the user-side server 1530 may receive the location information of the terminal 1520 or the ID of the cell with which the terminal 1520 is communicating from the terminal 1520. Through this process, the user-side server 1530 may provide the terminal 1520 with an intelligent model required for communication in the cell A 1511. Additionally, when the terminal 1520 moves from the cell A 1511 to the cell B 1512, the user-side server 1530 may provide the terminal 1520 with an intelligent model required for communication in the cell B 1512. Therefore, before communicating in the cell B 1512, the terminal 1520 may receive an intelligent model suitable for communication in the cell B 1512 from the user-side server 1530 and update the intelligent model when inter-cell movement occurs.

For the environment illustrated in FIG. 15B, the vendor of the terminal 1520 may need to construct and manage intelligent models that can operate in currently reported environments in advance. Additionally, the terminal 1520 may need to utilize measurement information of additional RSs to determine which of the multiple models stored in the OTT server can ensure performance under the current conditions. In this process, performance monitoring may also be used.

Meanwhile, to complement the method in which the terminal autonomously selects and manages an intelligent model, certain conditions may be imposed on beam patterns to enable intelligent beam management operations across multiple cells. In other words, limitations may be imposed on the beam patterns and indexing that the base station can configure, and certain information may be exchanged between the terminal and the base station to ensure consistency.

First, all base station beams that the base station can transmit will be described. Generally, the base station beams may be oriented at horizontal and vertical angles. Although an angular difference between adjacent beams may vary depending on a configuration of the base station. In order to share beam directions across multiple cells, the angular differences may be set at equal intervals (i.e. the same angular difference). Equal intervals may be applied to both the horizontal and vertical directions.

FIG. 16 is a conceptual diagram illustrating a case in which horizontal beams are indexed in a clockwise or counterclockwise direction at equal intervals.

Referring to FIG. 16, an example is illustrated in which indexing is performed in a clockwise direction 1620 or a counterclockwise direction 1610 for beams arranged at equal intervals to prevent random mixing (or misalignment) of beam indexes. When beam indexing is performed using one of the schemes illustrated in FIG. 16, even if the indexes are not identical, only a rotational shift of the indexes occurs. As a result, index correction alone may allow the prediction of beam directions across different cells.

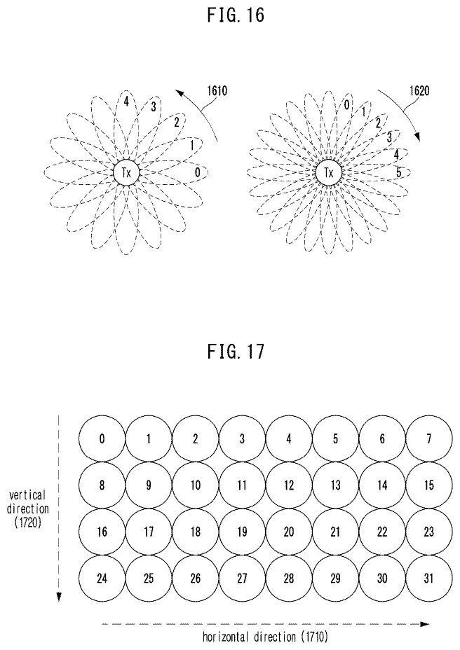

FIG. 17 is a conceptual diagram illustrating a case in which beam indexing is performed for both vertically equidistant beams and horizontally equidistant beams.

Referring to FIG. 17, an example is illustrated in which 4 beams spaced at equal intervals are configured in a vertical direction 1720, and 8 beams spaced at equal intervals are configured in a horizontal direction 1710. Additionally, as illustrated in FIG. 17, beam indexing is configured such that a beam index 0 is assigned to a beam positioned at one vertex of a quadrilateral, and indexes are sequentially assigned to 8 beams in the horizontal direction, a beam index 8 is then assigned to a beam located directly below the beam with the beam index 0, and indexes are sequentially assigned to 8 beams in the horizontal direction starting from the beam index 8. Similarly, a beam index 16 is assigned to a beam directly below the beam with the beam index 8, and indexes are sequentially assigned to 8 beams in the horizontal direction starting from the beam index 16. Finally, a beam index 24 is assigned to a beam directly below the beam with the beam index 16, and indexes are sequentially assigned to 8 beams starting from the beam index 24.

The beam indexing method illustrated in FIG. 17 is merely an example, and indexing may also be performed sequentially in the vertical direction. In such cases, indexing needs to still be performed in a predefined order for each beam.

Additionally, to ensure inter-cell consistency, the total number of beams, the number of horizontal beams, and the number of vertical beams need to be identical across all cells. However, even if the described rules for equal intervals and indexing are followed and the number of beams is consistent, consistency may not always be ensured.

For example, even if both beam patterns consist of 4 beams in the vertical direction, one beam pattern may be configured with angles of [−15, 15, 45, 75] degrees at 30-degree intervals from −15 degrees to 75 degrees, while another beam pattern may be configured with angles of [−25, 0, 25, 50] degrees at 25-degree intervals from −25 degrees to 50 degrees. In such cases, an intelligent model trained in one environment may not be ensured to provide the same performance in another environment.

Therefore, even if the above-described conditions are satisfied, a testing process is essential to verify the performance of an intelligent model trained in a different cell before using the trained intelligent model.

Hereinafter, cases related to beams used in the inference procedure will be described.

The first case is when selected beams (e.g. selected beams in FIG. 10A) are a subset of the total base station beams (e.g. total base station beams in FIG. 10A). In this case, if consistency has already been ensured through the conditions applied to the total base station beams, it is not necessary to separately consider the consistency of the selected beams. However, a rotation process may be required to align the indexing of the selected beams with the current cell's indexing. The terminal may transmit information on the selected beams whose indexes are rotated to the base station and request the use of the selected beams.

The second case is when selected beams (e.g. selected beams in FIG. 10A) are not a subset of the total base station beams (e.g. total base station beams in FIG. 10A). A representative example is when the selected beams have a wider beam pattern, while the total beams have a narrower beam pattern. In this case, even if consistency is ensured for the total beams, the consistency of the selected beams still needs to be considered.

Therefore, the selected beams need to also follow the same equal-interval and indexing rules as the total beams. Additionally, the number of selected beams, the number of horizontal selected beams, and the number of vertical selected beams need to match. Even if the selected beams satisfy the same conditions as the total beams, a testing process is still necessary to verify performance of an intelligent model trained in a different cell before using the trained intelligent model.

It should be noted that the seventh exemplary embodiment described above may be applied together with other exemplary embodiments described above and/or below as long as they do not conflict.

### Eighth Exemplary Embodiment

To perform intelligent beam management operations, configurations for both total beams (e.g. total base station beams in FIG. 10A) and selected beams (e.g. selected beams in FIG. 10A) are required. The configuration of total beams and selected beams may be performed by the base station using RRC IEs defined in the CSI framework of the current 5G NR technical specifications.

Some configuration parameters defined for CSI-ReportConfig in the current 5G NR technical specification may be as shown in Table 5 below.

TABLE 5

| | |
|---|---|
| CSI-ReportConfig ::= | SEQUENCE { |
| reportConfigId | CSI-ReportConfigId, |
| carrier | ServCellIndex |
| resourcesForChannelMeasurement | CSI-ResourceConfigId, |
| csi-IM-ResourcesForInterference | CSI-ResourceConfigId |
| nzp-CSI-RS-ResourcesForInterference | CSI-ResourceConfigId |
| } | |

The CSI-ReportConfig IE illustrated in Table 5 is distinguished by a reportConfigId parameter and may include information on resources for reporting (e.g. nzp-CSI-RS-Resources). The actual resource information is defined in a CSI-ResourceConfig IE, and the reportConfigId parameter may be associated with the CSI-ResourceConfigId IE. Similarly, resource information corresponding to the total beams (e.g. total base station beams in FIG. 10A) and the selected beams (e.g. selected beams in FIG. 10A) required for intelligent beam management may also be configured in the terminal by adding the CSI-ResourceConfig IE to the CSI-ReportConfig IE.

According to the 5G NR technical specification, the CSI-ResourceConfig IE is defined as shown in Table 6.

TABLE 6

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |
| nzp-CSI-RS-ResourceSetList | SEQUENCE (SIZE (1..maxNrofNZP-CSI- |

RS-ResourceSetsPerConfig)) OF NZP-CSI-RS-ResourceSetId

| | |
|---|---|
| csi-SSB-ResourceSetList | SEQUENCE (SIZE (1..maxNrofCSI-SSB- |

ResourceSetsPerConfig)) OF CSI-SSB-ResourceSetId
},

| | |
|---|---|
| csi-IM-ResourceSetList | SEQUENCE (SIZE (1..maxNrofCSI-IM- |

ResourceSetsPerConfig)) OF CSI-IM-ResourceSetId
},

| | |
|---|---|
| bwp-Id | BWP-Id, |
| resourceType | ENUMERATED { aperiodic, semiPersistent, periodic }, |

```
    ...,
  [[
```

| | |
|---|---|
| csi-SSB-ResourceSetListExt-r17 | CSI-SSB-ResourceSetId |

]]
}

The CSI-ResourceConfig IE includes a csi-ResourceConfigId parameter and may define one or more nzp-CSI-RS-ResourceSet parameters, csi-SSB-ResourceSet parameters, and csi-IM-ResourceSet parameters. Each resource set may be defined by including its corresponding resources.

The definition of total base station beams (i.e. total base station beams in FIG. 10A) and selected beams (i.e. selected beams in FIG. 10A) may be performed in several manners. The first method is to define both total base station beams and selected beams within a single CSI-ResourceConfig IE. In this case, total base station beams and selected beams are considered to be defined in the same environment. Therefore, a separate identifier for associating the total base station beams and the selected beams is not required.

The second method is to define total base station beams (i.e. total base station beams in FIG. 10A) and selected beams (i.e. selected beams in FIG. 10A) in separate CSI-ResourceConfig IEs.

The last method is to define selected beams (i.e. selected beams in FIG. 10A) using a CSI-ResourceConfig IE while defining total base station beams (i.e. total base station beams in FIG. 10A) using a separate IE or ResourceSet parameter. This method may be necessary because the number of total base station beams used in intelligent beam management may be significantly larger than the number of beams used in conventional beam management techniques. Therefore, a new scheme other than CSI-ReportConfig IE defined in the current 5G NR technical specification may be required to represent the total beams.

Meanwhile, the identifier introduced for differentiation within a cell in the sixth exemplary embodiment to ensure performance consistency, i.e., the association ID, may be included in the CSI-ReportConfig IE or CSI-ResourceConfig IE described above. For example, if total base station beams (e.g. total base station beams described in FIG. 10A) and selected beams (e.g. selected beams described in FIG. 10A) are defined in separate CSI-ResourceConfig IEs, an association ID may be newly defined within each CSI-ResourceConfig IE. This ensures that total base station beams and selected beams with the same value operate in the same environment (i.e. base station beam pattern). Using this method, one CSI-ResourceConfig IE defining total base station beams may be associated with multiple CSI-ResourceConfig IEs defining different selected beams.

It should be noted that the eighth exemplary embodiment described above may be applied together with other exemplary embodiments described above and/or below to the extent that they do not conflict.

Meanwhile, the methods described in the first through eighth exemplary embodiments are not independent but may be interrelated solutions. For example, technical configuration elements belonging to one proposed solution may be combined with technical configuration elements belonging to another proposed solution to form a new proposal. Additionally, newly composed proposals formed through a combination/aggregation of exemplary embodiments may be understood as part of the various exemplary embodiments of the present disclosure. In this manner, technical configuration elements selected from one proposed solution and technical configuration elements selected from another proposed solution may be combined/aggregated to construct various exemplary embodiments.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving, from a base station, channel state information (CSI)-related information including CSI resource configuration information;
measuring CSI-reference signals (CSI-RSs) respectively received through beams of the base station based on the CSI resource configuration information;
generating prediction information for the beams of the base station by using the measured CSI-RSs as inputs to an artificial intelligence (AI) model; and
transmitting a report message to the base station based on the prediction information for the beams of the base station.

2. The method according to claim 1, wherein in a data collection stage of the AI model, the report message is set to ‘No report’.

3. The method according to claim 1, wherein the report message further includes a parameter indicating an inference procedure of the AI model or a performance monitoring procedure of the AI model.

4. The method according to claim 1, wherein the report message includes only one or more beam indexes based on inference result of the AI model.

5. The method according to claim 1, wherein the report message includes first information corresponding to a first time instance, which is inferred from the AI model based on measurement of the CSI-RSs, and second information corresponding to a second time instance, which is predicted by the AI model based on measurement of the CSI-RSs, the first information includes pair(s) each comprising each of one or more first beam indexes obtained based on inference of the AI model and a measured received signal received power (RSRP) value corresponding to each of the one or more first beam indexes, and the second information includes pair(s) each comprising each of one or more second beam indexes obtained based on inference of the AI model and a predicted RSRP value corresponding to each of the one or more second beam indexes.

6. The method according to claim 5, wherein each of the RSRP value(s) in the second information is a difference from an RSRP value of a corresponding beam in the first information.

7. The method according to claim 5, wherein when a difference between the predicted RSRP value corresponding to each of the second beam index(es) included in the second information and an RSRP value corresponding to a beam index corresponding to each of the second beam index(es) included in the first information is within a preset threshold value, the predicted RSRP value is omitted from the second information.

8. The method according to claim 1, wherein the report message includes first information corresponding to a first time instance, which is inferred from the AI model based on measurement of the CSI-RSs, and second information corresponding to a second time instance, which is predicted by the AI model based on measurement of the CSI-RSs, the first information includes pair(s) each comprising each of odd-numbered beam index(es) obtained based on inference of the AI model and a measured RSRP value corresponding to each of the odd-numbered beam index(es), and the second information includes pair(s) each comprising each of even-numbered beam index(es) obtained based on inference of the AI model and a predicted RSRP value corresponding to each of the even-numbered beam index(es).

9. The method according to claim 1, wherein the CSI-related information further includes an identifier related to a pattern of the beams of the base station.

10. A terminal comprising at least one processor, wherein the at least one processor causes the terminal to perform:
receiving, from a base station, channel state information (CSI)-related information including CSI resource configuration information;
measuring CSI-reference signals (CSI-RSs) respectively received through beams of the base station based on the CSI resource configuration information;
generating prediction information for the beams of the base station by using the measured CSI-RSs as inputs to an artificial intelligence (AI) model; and
transmitting a report message to the base station based on the prediction information for the beams of the base station.

11. The terminal according to claim 10, wherein in a data collection stage of the AI model, the report message is set to ‘No report’.

12. The terminal according to claim 10, wherein the report message further includes a parameter indicating an inference procedure of the AI model or a performance monitoring procedure of the AI model.

13. The terminal according to claim 10, wherein the report message includes only one or more beam indexes based on inference result of the AI model.

14. The terminal according to claim 10, wherein the report message includes first information corresponding to a first time instance, which is inferred from the AI model based on measurement of the CSI-RSs, and second information corresponding to a second time instance, which is predicted by the AI model based on measurement of the CSI-RSs, the first information includes pair(s) each comprising each of one or more first beam indexes obtained based on inference of the AI model and a measured received signal received power (RSRP) value corresponding to each of the one or more first beam indexes, and the second information includes pair(s) each comprising each of one or more second beam indexes obtained based on inference of the AI model and a predicted RSRP value corresponding to each of the one or more second beam indexes.

15. The terminal according to claim 14, wherein each of the RSRP value(s) in the second information is a difference from an RSRP value of a corresponding beam in the first information.

16. The terminal according to claim 14, wherein when a difference between the predicted RSRP value corresponding to each of the second beam index(es) included in the second information and an RSRP value corresponding to a beam index corresponding to each of the second beam index(es) included in the first information is within a preset threshold value, the predicted RSRP value is omitted from the second information.

17. The terminal according to claim 10, wherein the report message includes first information corresponding to a first time instance, which is inferred from the AI model based on measurement of the CSI-RSs, and second information corresponding to a second time instance, which is predicted by the AI model based on measurement of the CSI-RSs, the first information includes pair(s) each comprising each of odd-numbered beam index(es) obtained based on inference of the AI model and a measured RSRP value corresponding to each of the odd-numbered beam index(es), and the second information includes pair(s) each comprising each of even-numbered beam index(es) obtained based on inference of the AI model and a predicted RSRP value corresponding to each of the even-numbered beam index(es).

18. The terminal according to claim 10, wherein the CSI-related information further includes an identifier related to a pattern of the beams of the base station.

19. A method of a base station, comprising:
transmitting, to a terminal, channel state information (CSI)-related information including CSI resource configuration information;
transmitting, to the terminal, CSI-reference signals (CSI-RSs) respectively through beams of the base station based on the CSI resource configuration information; and
receiving a report message from the terminal,
wherein the report message includes prediction information for the beams of the base station obtained by an artificial intelligence (AI) model included in the terminal.

20. The method according to claim 19, wherein when the report message is set to ‘No report’, a data collection stage of the AI model is identified for the terminal.
